(19) United States
(12) Patent Application Publication
(10) Pub. No.: US 2020/0193421 A1
(43) Pub. Date: Jun. 18, 2020

(54) METHODS AND SYSTEMS FOR PROVIDING A UNIVERSAL, GLOBAL, VIRTUAL WALLET TO MERCHANT PAYMENT SYSTEM ADAPTER

(71) Applicant: Omnyway, Inc., San Mateo, CA (US)

(72) Inventors: Amitaabh Malhotra, San Carlos, CA (US); Ashok Narasimhan, San Francisco, CA (US); Mohammad Khan, San Jose, CA (US)

(73) Assignee: Omnyway, Inc., San Mateo, CA (US)

(21) Appl. No.: 16/639,977

(22) PCT Filed: Aug. 16, 2018
(86) PCT No.: PCT/IB2018/056209

§ 371 Date: Feb. 18, 2020

Related U.S. Application Data
(60) Provisional application No. 62/546,541, filed on Aug. 16, 2017.

(51) Int. Cl. G06Q 20/36; G06Q 20/20; G06Q 20/38; G06Q 20/32

(52) U.S. Cl. CPC G06Q 20/3678; G06Q 20/3221; G06Q 20/381; G06Q 20/204

(57) ABSTRACT

Methods and systems for providing a universal, global, virtual wallet to merchant payment system adapter are provided. The present disclosure provides the physical and logical infrastructure to provide a universal interface between any type of payment or money transfer system and any payment acceptance system, and specifically bridges the gap between “wallets”, i.e., systems that transfer funds between users but can't be used with traditional card payment acceptance systems, and traditional card payment acceptance systems such as debit, credit, and prepaid cards, which may be a physical card that can be swiped, chip inserted, or NFC tapped. According to one aspect, a third-party server coordinates a transfer of funds from a user's wallet account directly to a merchant's debit card, which the merchant swipes at the POS terminal to complete the desired transaction.

### RELATED APPLICATIONS

This application claims the benefit of provisional application Ser. No. 62/546,541, filed Aug. 16, 2017, the disclosure of which is hereby incorporated herein by reference in its entirety.

### FIELD OF THE DISCLOSURE

The present disclosure relates to methods and systems that allow tourists having foreign bank accounts access to domestic payment instruments. More specifically, the present disclosure relates to methods and systems for providing a universal, global, virtual-to-physical payment adapter.

### BACKGROUND OF THE INVENTION

A country may have large numbers of visitors (e.g., tourists) every year. These visitors may have accounts at financial institutions in their home country but none in the visited country, or may possess a credit or debit card that is not accepted in the visited country, making it difficult for those visitors to engage in commerce in the visited country. Most retailers in other parts of the world do not have a mechanism in place to accept alternative payment methods, especially in physical retail.

Using the United States (US) as an example, in 2016, four million Chinese tourists visit the US every year, and spent about billion dollars on goods outside of travel, food, on lodging, averaging about $2500 per person per trip.

The US is an attractive tourist destination for Chinese tourists in particular due to the availability of a wide range of possible items, including non-counterfeit items. Chinese tourists tend to be large consumers of luxury goods and often buy in bulk, and are mostly directed by tour operators to locations where they can shop.

However, unlike the US, where credit cards such as MasterCard™ and VISA™, are ubiquitous, the use of these credit cards in China is very small, which means that most Chinese tourists do not have a Visa or MasterCard credit card, in which case transactions must be done in cash. A Chinese tourist can get a credit or debit card from China's UnionPay Bank, but this card is not accepted in many places in the US, in which case transactions again must to be done in cash. Either situation tends to restrict how much a visitor can spend in a physical store.

Furthermore, many Chinese do not use credit cards at all, and instead preferring to use WeChatPay™—a payment and money transfer feature of the messaging application WeChat™—for electronic payments (rather than cash) for many day-to-day purchases, and to use AliPay™ from AliBaba™ for making online payment of goods—similar to the use of PayPal™ in the US, and may also use AliPay mobile app for purchases in the physical stores.

As a result, there are significant barriers that prevent a Chinese tourist, for example, to engage in commercial transactions in the US. Enabling a US merchant to accept a UnionPay Bank credit card, a WeChat funds transfer, or an AliPay electronic transaction would require a significant and expensive change to the existing electronic payment infrastructure, and this is just in regard to two countries: Chinese visitors to the US.

The same barriers may exist to prevent visitors from countries other than China and for visitors to countries other than the US. Additional infrastructure changes may be required for each additional country supported as either a source of visitors or a target destination for those visitors.

Thus, there is a need to allow visitors from one country to perform commercial transactions within another country in the absence of a commonly supported payment instrument.

### SUMMARY OF THE INVENTION

Methods and systems for providing a universal, global, virtual-to-physical payment adapter are provided. The subject matter of the present disclosure provides the physical and logical infrastructure to provide a universal interface between any type of payment or money transfer system and any payment acceptance system, and specifically bridges the gap between systems that transfer funds but can't directly to make purchases and the payment acceptance systems that process such purchases (such as Visa, Discover, Mastercard, BharatQR, WeChat Pay, and other payment systems used by merchants). In some embodiments, certain functionality is provided by an Omnyway Payment Server (OPS), which may include software, circuitry, processors, memory, and/or other hardware. The functions of an OPS may be distributed among multiple hardware entities and may be distributed across multiple physical, geographic, and/or logical locations.

In one application, for example, the methods and systems disclosed herein provide a bridge between social or mobile wallet applications that allow transfer of funds from person to person (e.g., Venmo, Zelle and others) and traditional payment methods including prepaid, debit, and credit cards (in physical or digital/virtual form) as currently accepted by the existing payment acceptance infrastructure. Such an application may be referred to as a Virtual-To-Physical Payment (V2PP) application or service.

In another application, for example, the subject of the present disclosure enables visitors from one country to make purchases, payments, or other transactions using the financial systems of another country. In one embodiment, methods and systems of the present disclosure offer a visitor to another country the freedom to use the visitor's preferred mobile payment method at physical retail stores in countries that they are visiting.

In one example scenario, Chinese tourists can make payments at US merchants using payment mechanisms already extant in the US. According to one embodiment, which will be described in more detail below, such a transaction may take place at a backend server in China (via WeChat, for example) while the US merchant is paid in dollars, with no change required at the merchant's Point Of Sale (POS) front-end.

In a second example scenario, US residents, tourists or visitors can use a mobile app or a personal computer to make payments at Chinese merchants using payment mechanisms already extant in China. According to one embodiment, which will be described in more detail below, such a transaction may take place at a backend server in or outside of China (via Visa, Mastercard, Discover, Venmo, or other payment schemes) while the Chinese merchant is paid in RMB, with no change required at the merchant's Point Of Sale (POS) front-end or eCommerce site.

Such an application for either scenario may be referred to as a Global Traveler Payment (GTP) application or service. It will be understood that V2PP and GTP may be considered different aspects of the services provided by an OPS.

The methods and systems of the present disclosure have utility far beyond enabling global traveler payments, however: they can be used to connect any type of payment or money transfer system with any payment acceptance system in one or more countries, whether the two systems are in the same country or in different countries. As such, the term “foreign” is used to mean “foreign to the existing payment acceptance infrastructure” rather than “foreign country”—although in some scenarios the payment or money transfer system and/or the payment acceptance infrastructure may indeed be in a foreign country or in different countries from each other.

A significant advantage that the methods and systems of the present disclosure have over prior art systems is that subject matter of the present disclosure allows the use of pre-existing payment systems without modification, e.g., requiring no software or hardware change in the existing POS system of a merchant.

According to one aspect of the present disclosure, a method for providing for providing a universal, global, virtual-to-physical payment adapter comprises receiving information associated with a desired domestic transaction, the information including information identifying a user and an amount in a first currency; converting the amount in the first currency to an amount in a second currency; sending information including the amount in the second currency; receiving an instruction to initiate the desired transaction;

sending, to a foreign bank, a request to authorize the desired transaction, the request including information for identifying the user and the amount in the second currency; receiving, from the foreign bank, authorization of the desired transaction, the authorization including information identifying the user; determining a card number or otherwise identifying a payment instrument associated with the identified user; sending, to a domestic bank, a request that funds be added to the payment instrument and/or that a credit limit of the payment instrument be changed;
receiving, from the domestic bank, a result of that request; and sending, to the identified user, an instruction to present the payment instrument to a merchant involved in the desired transaction.

According to another aspect of the present disclosure, a Omnyway Payment Server (OPS) server for providing a universal, global, virtual-to-physical payment adapter comprises at least one processor, and memory comprising instructions executable by the at least one processor whereby the process is adapted to operate according to any of the methods of the present disclosure.

According to yet another aspect of the present disclosure, an OPS server for providing a universal, global, virtual-to-physical payment adapter comprises one or more modules whereby the OPS server is adapted to operate according to any of the methods of the present disclosure.

According to yet another aspect of the present disclosure, an OPS server for providing a universal, global, virtual-to-physical payment adapter is adapted to operate according to any of the methods of the present disclosure

According to yet another aspect of the present disclosure, a computer program comprises instructions which, when executed on at least one processor, cause the at least one processor to carry out any of the methods of the present disclosure.

According to yet another aspect of the present disclosure, a carrier contains the computer program above, wherein the carrier is one of an electronic signal, an optical signal, a radio signal, or a computer readable storage medium.

According to yet another aspect of the present disclosure, an OPS may present participating local merchants's offers and/or product information graphically, in text, or in voice to (local or traveler) users through social media app, mobile app, or a personal computer to show merchants using virtual-to-physical payment adapter to users, and may also incite users through discounts or offers to visit and make purchases at participating local merchants using computer program comprises instructions which, when executed on at least one processor, cause the at least one processor to carry out any of the methods of the present disclosure.

According to one aspect of the present disclosure, a method for providing a universal, global, virtual-to-physical payment adapter comprises: receiving first information associated with a desired transaction, the information comprising information identifying a user and an amount; sending, to a first financial entity, a request to authorize the desired transaction, the request comprising information for identifying the user and the amount; receiving, from the first financial entity, authorization of the desired transaction, the authorization comprising information identifying the user; determining a payment instrument or financial account to be involved in the transaction; sending, to a second financial entity, a request to prepare the payment instrument or financial account for the desired transaction; receiving, from the second financial entity, a result of that request; and sending, to the identified user, an instruction to initiate the desired transaction.

In some embodiments, the first financial entity and the second financial entity comprise domestic banks.

In some embodiments, the first financial entity comprises a foreign bank and wherein the second financial entity comprises a domestic bank; or the first financial entity comprises a domestic bank and wherein the second financial entity comprises a foreign bank and wherein receiving the first information comprises receiving the first information from a mobile application or personal computer of the user.

In some embodiments, receiving the information identifying an amount comprises receiving information identifying an amount in a first currency and wherein the method further comprises, prior to sending the request to authorize the desired transaction: converting the amount in the first currency to an amount in a second currency; sending the amount in the second currency to the user for approval; and receiving from the user approval to send the request to authorize the desired transaction.

In some embodiments, determining the payment instrument or financial account to be involved in the transaction comprises determining a payment instrument to be involved in the transaction; sending the request to prepare the payment instrument or financial account for the desired transaction comprises sending a request that funds be added to the payment instrument and/or that a credit limit of the payment instrument be changed; and sending the instruction to initiate the desired transaction comprises sending an instruction to present the payment instrument to a merchant involved in the desired transaction for processing by the merchant.

In some embodiments, receiving the first information further comprises receiving information identifying a Point Of Sale, POS, terminal or other merchant equipment for performing a transaction; determining the payment instrument or financial account to be involved in the transaction comprises determining a financial account associated with the merchant equipment; sending the request to prepare the payment instrument or financial account for the desired transaction comprises sending a request that funds be added to the financial account and/or that a credit limit of the financial account be changed; and sending the instruction to initiate the desired transaction comprises sending an instruction to request the merchant to process the desired transaction using the financial account associated with the merchant equipment.

In some embodiments, the method further comprises: receiving an indication of the result of the processed transaction; and notifying the user of the result of the processed transaction.

According to another aspect of the present disclosure, a payment server for providing a universal, global, virtual-to-physical payment adapter comprises: at least one processor; and memory comprising instructions executable by the at least one processor whereby the payment server is configured to: receive first information associated with a desired transaction, the information comprising information identifying a user and an amount; send, to a first financial entity, a request to authorize the desired transaction, the request comprising information for identifying the user and the amount; receive, from the first financial entity, authorization of the desired transaction, the authorization comprising information identifying the user; determine a payment instrument or financial account to be involved in the transaction; send, to a second financial entity, a request to prepare the payment instrument or financial account for the desired transaction; receive, from the second financial entity, a result of that request; and send, to the identified user, an instruction to initiate the desired transaction.

In some embodiments, the first financial entity and the second financial entity comprise domestic banks.

In some embodiments, the first financial entity comprises a foreign bank and wherein the second financial entity comprises a domestic bank.

In some embodiments, receiving the information identifying an amount comprises receiving information identifying an amount in a first currency and wherein the payment server is further configured to, prior to sending the request to authorize the desired transaction: convert the amount in the first currency to an amount in a second currency; send the amount in the second currency to the user for approval; and receive from the user approval to send the request to authorize the desired transaction.

In some embodiments, determining the payment instrument or financial account to be involved in the transaction comprises determining a payment instrument to be involved in the transaction; sending the request to prepare the payment instrument or financial account for the desired transaction comprises sending a request that funds be added to the payment instrument and/or that a credit limit of the payment instrument be changed; and sending the instruction to initiate the desired transaction comprises sending an instruction to present the payment instrument to a merchant involved in the desired transaction for processing by the merchant.

In some embodiments, receiving the first information further comprises receiving information identifying a Point Of Sale (POS) terminal or other merchant equipment for performing a transaction; determining the payment instrument or financial account to be involved in the transaction comprises determining a financial account associated with the merchant equipment; sending the request to prepare the payment instrument or financial account for the desired transaction comprises sending a request that funds be added to the financial account and/or that a credit limit of the financial account be changed; and sending the instruction to initiate the desired transaction comprises sending an instruction to request the merchant to process the desired transaction using the financial account associated with the merchant equipment.

In some embodiments, the payment server is further configured to: receive an indication of the result of the processed transaction; and notify the user of the result of the processed transaction.

In some embodiments, the payment server is further configured to: present participating local merchants' offers and/or product information graphically, in text, or in voice to users; identify merchants that support the services provided by the payment server; and/or incite users through discounts or offers to visit and make purchases at participating local merchants.

In some embodiments, the payment server provides notifications to the user via a social media app, a mobile app, or a personal computer.

According to another aspect of the present disclosure, a payment server for providing a universal, global, virtual-to-physical payment adapter is configured to: receive first information associated with a desired transaction, the information comprising information identifying a user and an amount; send, to a first financial entity, a request to authorize the desired transaction, the request comprising information for identifying the user and the amount; receive, from the first financial entity, authorization of the desired transaction, the authorization comprising information identifying the user; determine a payment instrument or financial account to be involved in the transaction; send, to a second financial entity, a request to prepare the payment instrument or financial account for the desired transaction; receive, from the second financial entity, a result of that request; and send, to the identified user, an instruction to initiate the desired transaction.

In some embodiments, the payment server is configured to perform any of the methods described herein.

According to another aspect of the present disclosure, a payment server for providing a universal, global, virtual-to-physical payment adapter comprises one or more modules operable to: receive first information associated with a desired transaction, the information comprising information identifying a user and an amount; send, to a first financial entity, a request to authorize the desired transaction, the request comprising information for identifying the user and the amount; receive, from the first financial entity, authorization of the desired transaction, the authorization comprising information identifying the user; determine a payment instrument or financial account to be involved in the transaction; send, to a second financial entity, a request to prepare the payment instrument or financial account for the desired transaction; receive, from the second financial entity, a result of that request; and send, to the identified user, an instruction to initiate the desired transaction.

In some embodiments, the one or more modules are further operable to perform any of the methods described herein.

According to another aspect of the present disclosure, a non-transitory computer readable medium stores software instructions that, when executed on at least one processor, cause the at least one processor to: receive first information associated with a desired transaction, the information comprising information identifying a user and an amount; send, to a first financial entity, a request to authorize the desired transaction, the request comprising information for identifying the user and the amount; receive, from the first financial entity, authorization of the desired transaction, the authorization comprising information identifying the user; determine a payment instrument or financial account to be involved in the transaction; send, to a second financial entity, a request to prepare the payment instrument or financial account for the desired transaction; receive, from the second financial entity, a result of that request; and send, to the identified user, an instruction to initiate the desired transaction.

According to another aspect of the present disclosure, a computer program comprises instructions which, when executed on at least one processor, cause the at least one processor to: receive first information associated with a desired transaction, the information comprising information identifying a user and an amount; send, to a first financial entity, a request to authorize the desired transaction, the request comprising information for identifying the user and the amount; receive, from the first financial entity, authorization of the desired transaction, the authorization comprising information identifying the user; determine a payment instrument or financial account to be involved in the transaction; send, to a second financial entity, a request to prepare the payment instrument or financial account for the desired transaction; receive, from the second financial entity, a result of that request; and send, to the identified user, an instruction to initiate the desired transaction.

### BRIEF DESCRIPTION OF THE DRAWING FIGURES

The accompanying drawing figures incorporated in and forming a part of this specification illustrate several aspects of the invention, and together with the description serve to explain the principles of the invention.

FIGS. 1A and 1B are block diagrams illustrating an exemplary system for providing a universal, global, virtual-to-physical payment adapter according to embodiments of the present disclosure.

FIGS. 2A, 2B, 3, and 4 are signaling diagrams illustrating portions of an exemplary process for providing a universal, global, virtual-to-physical payment adapter according to an embodiment of the present disclosure.

FIGS. 3A and 3B are diagram illustrating another portion of an exemplary process for providing OPS services according to another embodiment of the present disclosure, using a User's Card.

FIGS. 4A and 4B are diagram illustrating another portion of an exemplary process for providing OPS services according to another embodiment of the present disclosure, using a Merchant's Card/Account.

FIG. 5A is block diagram illustrating an exemplary payment server for providing OPS services according to another embodiment of the present disclosure.

FIG. 5B is block diagram illustrating an exemplary payment server for providing OPS services according to another embodiment of the present disclosure.

FIG. 6 illustrates an embodiment of the present disclosure in which payment functions are handled by the WeChat™ application

FIGS. 7A through 7J represent example steps of the processes described in FIGS. 2A, 2B, 3, and 4, including examples of information that may be provided to the user via his or her smartphone.

FIG. 8A illustrates another embodiment of the present disclosure, showing the various relationships that may exist among the parties.

FIG. 8B illustrates yet another embodiment of the present disclosure, which is an alternative to the embodiment shown in FIG. 8A.

FIG. 9 is a flow chart illustrating an exemplary method for providing a universal, global, virtual-to-physical payment adapter according to an embodiment of the present disclosure.

FIG. 10 is a flow chart illustrating an exemplary method for providing a universal, global, virtual-to-physical payment adapter according to another embodiment of the present disclosure.

FIG. 11 is a flow chart illustrating an exemplary method for providing a universal, global, virtual-to-physical payment adapter according to another embodiment of the present disclosure.

FIG. 12 is a flow chart illustrating an exemplary method for providing a universal, global, virtual-to-physical payment adapter according to another embodiment of the present disclosure.

FIGS. 13 through 15 illustrate various aspects of the physical card according to different embodiments of the present disclosure.

FIGS. 16 and 17 illustrate example flows for exemplary Merchant

Card embodiments according to embodiments of the present disclosure.

FIGS. 18 through 20 illustrate example flows for exemplary User Card embodiments according to embodiments of the present disclosure.

FIG. 21 is a diagram illustrating exemplary relationships between entities engaged in a system for providing a universal, global, virtual-to-physical payment adapter according to another embodiment of the present disclosure.

FIG. 22 includes additional information regarding embodiments that use virtual, rather than physical, cards.

FIGS. 23 and 24 include tables that list roles and exemplary entities that might perform these roles in various scenarios contemplated by the subject matter of the present disclosure.

FIGS. 25 through 28 are flow charts illustrating portions of an exemplary process for providing a universal, global, virtual-to-physical payment adapter according to another embodiment of the present disclosure.

FIG. 29 through 66 are screen shots showing how such processes may appear to a user who is using a smart phone, tablet, or other graphic device to interact with a system for providing a universal, global, virtual-to-physical payment adapter according to another embodiment of the present disclosure.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

Methods and systems for providing a universal virtual to physical payment adapter are presented herein. The subject matter of the present disclosure provides the physical and logical infrastructure to provide a universal interface between any type of payment or money transfer system and any payment acceptance system, and specifically bridges the gap between systems that transfer funds but can't directly to make purchases and the payment acceptance systems that process such purchases (such as Visa, Discover, Mastercard, AliPay, WeChat Pay, BharatQR and other systems used by merchants).

In one application, for example, the methods and systems disclosed herein provide a bridge between social or mobile wallet applications that allow transfer of funds from person to person (e.g., Venmo, Zelle and others) and traditional payment methods including prepaid, debit, and credit cards (in physical or digital form) as currently accepted by the existing payment acceptance infrastructure.

In another application, for example, the subject of the present disclosure enables visitors from one country to make purchases, payments, or other transactions using the financial systems of another country. For example, Chinese tourists can make payments at US merchants using payment mechanisms already extant in the US. According to one embodiment, which will be described in more detail below, such a transaction may take place at a backend server in China (via WeChat, for example) while the US merchant is paid in dollars, with no change required at the merchant's Point Of Sale (POS) front-end. Such an application may be referred to as a Omnyway Payment Server (OPS) application or service.

The methods and systems of the present disclosure have utility far beyond enabling global traveler payments, however: they can be used to connect any type of payment or money transfer system with any payment acceptance system in one or more countries, whether the two systems are in the same country or in different countries. As such, the term “foreign” is used to mean “foreign to the existing payment acceptance infrastructure” rather than “foreign country”—although in some scenarios the payment or money transfer system and/or the payment acceptance infrastructure may indeed be in a foreign country or in different countries from each other.

A significant advantage that the methods and systems of the present disclosure have over prior art systems is that subject matter of the present disclosure allows the use of pre-existing payment systems without modification, e.g., requiring no software or hardware change in the existing POS system of a merchant.

As used herein, the term “authorization” refers to the process by which a financial system determines whether or not a buyer has sufficient funds to complete a purchase or other financial transaction. If so, the transaction is authorized; if not, the transaction is denied. Authorization happens in real time, at the time the transaction is attempted (e.g., when the buyer “swipes” his or her credit card at a POS terminal).

As used herein, the term “settlement” refers to the process that takes place after successful authorization in which funds are transferred from an account of the buyer to an account of the seller (e.g., the retailers get their money from the sale). Settlement happens after authorization, sometimes hours or days later.

As used herein, the term “application”, when used as a noun, refers to a software program that runs or is hosted on a computing device, such as a personal computer, smartphone, or other electronic device. An application may alternatively be referred to as “an app”.

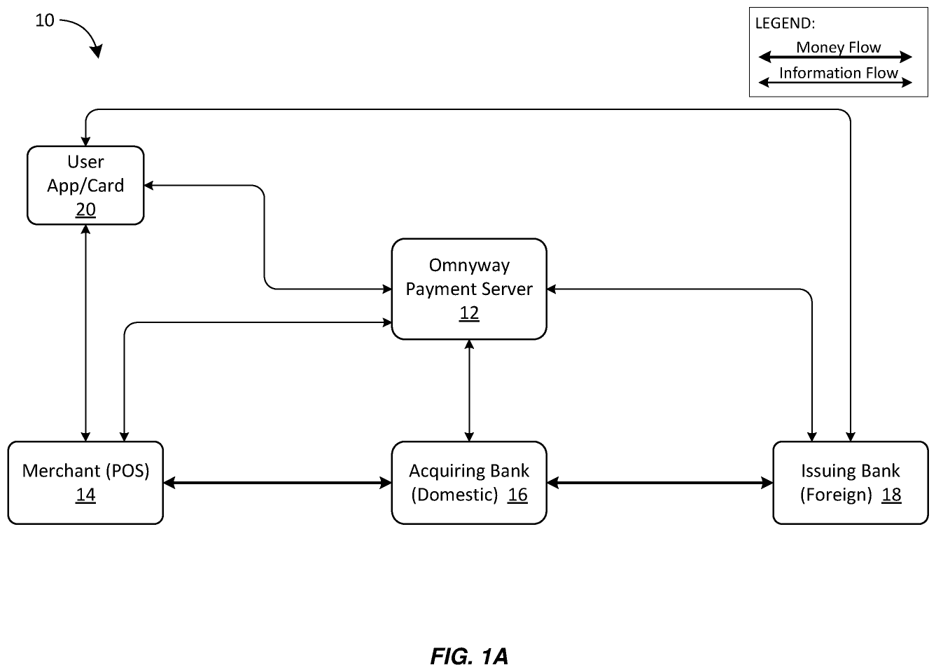

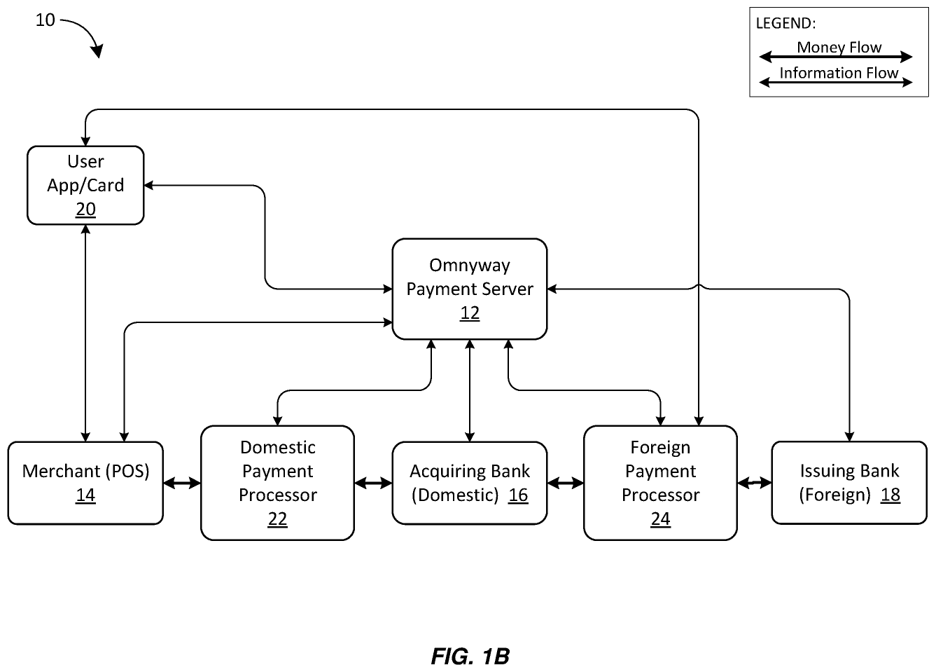

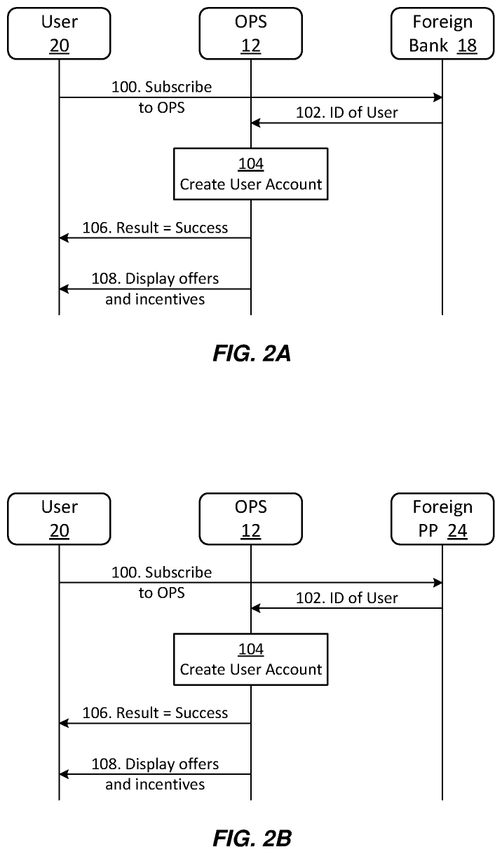

FIGS. 1A and 1B are block diagrams illustrating an exemplary system for providing a universal, global, virtual-to-physical payment adapter according to embodiments of the present disclosure. In FIGS. 1A and 2B, thick lines represent the flow of money (e.g., fund transfers, pre-paid card balance adjustments, etc.) and thin lines represent the flow of information.

In the embodiment illustrated in FIG. 1A, system 10 includes an Omnyway Payment Server (OPS) 12, which acts as an intermediary to coordinate transfers of funds between a merchant 14, a domestic entity that handles domestic payment transactions, such as a domestic Acquiring Bank 16, and a foreign entity that handles foreign payment transactions, such as a foreign Issuing Bank 18. In one embodiment, a user 20 may use an application in conjunction with a physical or virtual card to perform a domestic purchase as will be described in more detail below. In another embodiment, a user 20 may use the system 10 to perform a Global Traveler Payment (GTP) purchase as will also be described in more detail below. In these embodiments, the OPS 12 may alternatively be referred to as “the GTP server 12”, or simply “the GTP 12”.

The merchant 14 may comprise a Point Of Sale (POS) terminal or an internet connected device accepting online payments (smartphone, tablet, PC, etc.), in which case the merchant 14 may also be referred to herein as “the merchant POS 14” or “the POS 14”. The Acquiring Bank 16 may also be referred to herein as “the domestic bank 16”, “the domestic financial entity 16”, or “the domestic entity 16”. The Issuing Bank 18 may also be referred to herein as “the foreign bank 18”, “the foreign financial entity 18”, or “the foreign entity 18”.

In the embodiment illustrated in FIG. 1B, a domestic payment processor 22 may be involved in the transfer of funds between the merchant 14 and the domestic bank 16. In one embodiment, the domestic payment processor 22 comprises a prepaid card issuer/processor, and thus may also be referred to as “the prepaid processor 22”. In other embodiments the payment processing entity 22 may be a virtual card issuer/processor, and thus may also be referred to as “the virtual card processor 22”.

In the embodiment illustrated in FIG. 1B, a foreign payment scheme/processor 24 may be involved in the transfer of funds between the domestic bank 16 and the foreign bank 18. In one embodiment, for example, the foreign payment scheme/processor 24 may be a service such as WeChatPay™. The foreign payment scheme/processor 24 may alternatively be referred to herein as “the foreign payment processor 24” or simply “Foreign PP 24”.

An example operation of system 10 will now be described.

FIGS. 2A, 2B, 3, and 4 are signaling diagrams illustrating portions of an exemplary process for providing a universal, global, virtual-to-physical payment adapter according to an embodiment of the present disclosure.

FIG. 2A illustrates a signup or subscription portion of an exemplary process for providing a universal, global, virtual-to-physical payment adapter according to an embodiment of the present disclosure. This portion of the process may take place in the traveler's home country. In the embodiment illustrated in FIG. 2A, a user's device 20 (which may also be referred to herein as simply “a user 20”) sends a request (message 100) to the foreign bank 18 to subscribe to, create an account on, or otherwise use the Omnyway Payment Server (OPS) services that are hosted by the OPS 12. The foreign bank 18 communicates this request to the OPS 12 (message 102), which creates a user account (step 104). The OPS 12 notifies the user 20 of the result, which in this example is a successful creation of the user account (message 106). In the embodiment illustrated in FIG. 2A, the OPS 12 may display offers and incentives to the user 20.

FIG. 2B illustrates a signup or subscription portion of an exemplary process for providing OPS services according to another embodiment of the present disclosure. The process illustrated in FIG. 2B is almost identical to the one shown in FIG. 2A, except that a Foreign Payment Processor (PP) 24 performs the steps that were performed by the Foreign Bank 18 in FIG. 2A. The descriptions of message 100, message 102, block 104, message 106, and message 108 will not be repeated here. Examples of Foreign PPs include, but are not limited to, WeChatPay™, AliPay™, Foreign real-time ACH networks, and the like.

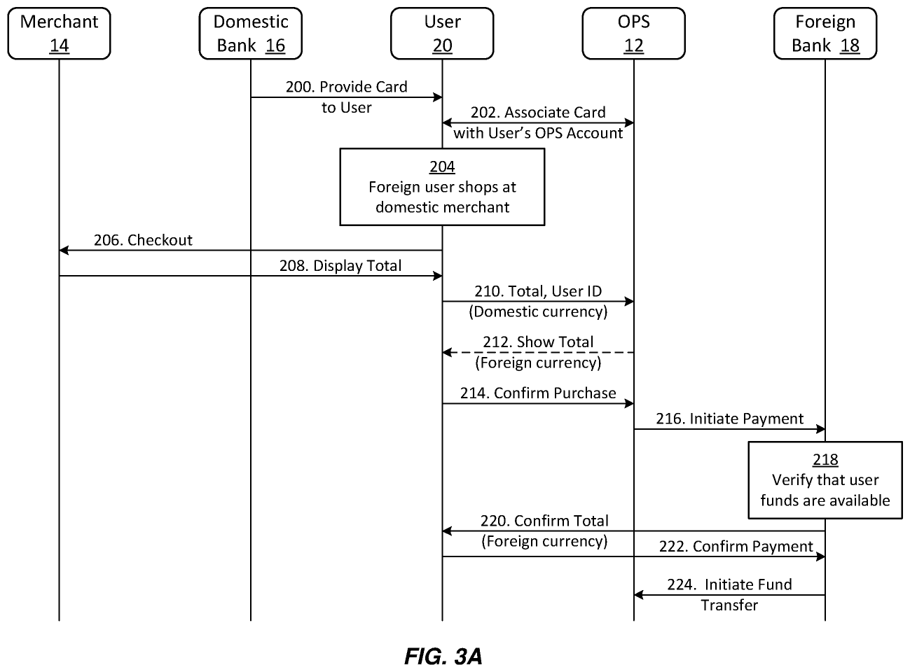

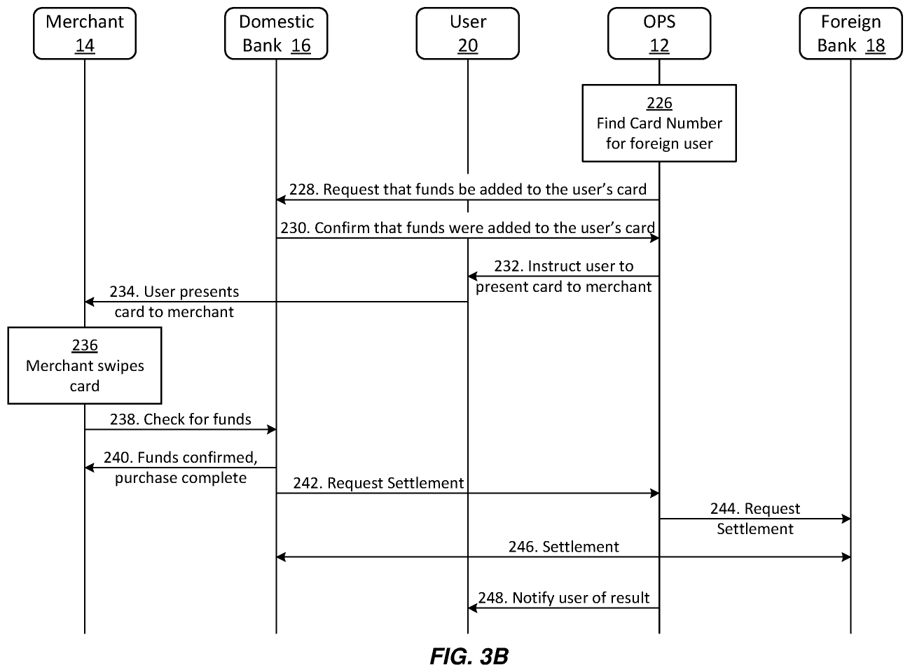

FIG. 3A is diagram illustrating another portion of an exemplary process for providing OPS services according to another embodiment of the present disclosure, where a User's Card is used. FIG. 3A illustrates an interaction between a merchant 14, a domestic bank 16, a user 20, an OPS 12, and a foreign bank 18, such as the like-numbered entities shown in FIGS. 1 A and 1B and described above. The interaction illustrated in FIG. 3A typically occurs when the user 20 has traveled from his or her home country, where the foreign bank 18 is located, and has arrived in the destination country, where the domestic bank 16 is located. That is, in this example, the term “foreign” refers to the user's home country and the term “domestic” refers to the country where the user is visiting. For a Chinese tourist visiting the US, for example, the Foreign Bank 18 is a Chinese bank and the Domestic Bank 16 is a US bank.

In the embodiment illustrated in FIG. 3A, the Domestic Bank 16 will provide a physical credit card to the user 20 (step 200), typically upon arrival in the domestic country. The user 20 will associate the physical card with the user's OPS account (step 202), e.g., the account created in step 104 of FIG. 1A or FIG. 1B. In one embodiment, this may be done by entering the card number into an OPS application on the user's smartphone, which communicates this information to the OPS 12. In one embodiment, the OPS 12 may notify the user 20 whether or not the card was successfully associated with the OPS account of the user 20.

At step 204, the user 20 begins to shop, e.g., at a physical or online store of the merchant 14. In the embodiment illustrated in FIG. 3A, when the user initiates checkout (step 206), the merchant 14 will display, present, or otherwise provide (which will hereinafter be referred to simply as “present” or “display”) the total to the user 20 (step 208) in the domestic currency. In the embodiment illustrated in FIG. 3A, the user 20 communicates the total in the domestic currency to the OPS 12. In one embodiment, the user 20 enters the total into the OPS application on their smartphone. In the embodiment illustrated in FIG. 3A, the OPS 12 will display to the user 20 the total in the foreign currency, e.g., in the currency that the user 20 is familiar with (step 212).

In one embodiment, if the user 20 decides to complete the purchase, the user 20 may notify the OPS 12 by sending a instruction or request to confirm the purchase (step 214), e.g., by tapping on a “confirm purchase?” button on the OPS application or other means. In one embodiment, upon receiving the confirmation in step 214, the OPS 12 will initiate a request for payment from the foreign bank 18 (step 216). In the embodiment illustrated in FIG. 3A, the foreign bank 18 verifies that the user 20 has sufficient funds in his or her account (step 218), and if so, will display to the user 20 the final total for the transaction, which may include additional transaction or processing fees, taxes, or other fees (step 220). In the embodiment illustrated in FIG. 3A, the user 20 then confirms payment (step 222), after which the foreign bank 18 will initiate a fund transfer. In the embodiment illustrated in FIG. 3A, the foreign bank 18 transfers funds, e.g., the payment amount, to the OPS 12 (step 224). In one embodiment, the OPS 12 acts as an intermediary or escrow between the foreign bank 18 and the domestic bank 16/merchant 14. This process continues in FIG. 3B.

FIG. 3B is diagram illustrating another portion of an exemplary process for providing OPS services according to another embodiment of the present disclosure, where a User's Card is used. FIG. 3B illustrates a continued interaction between the merchant 14, the domestic bank 16, the user 20, the OPS 12, and the foreign bank 18.

In the embodiment illustrated in FIG. 3B, the OPS 12 determines the card number associated with the (foreign) user 20 (step 300), and then issues a request to the domestic bank 16 (step 302) to add funds to that card (e.g., if the card is a prepaid card) or to set the credit limit of that card (e.g., if the card is a credit card) sufficient to cover the payment amount (i.e., the total purchase amount). In one embodiment, the added funds or allowed credit limit may be set to exactly the total purchase amount. In the embodiment illustrated in FIG. 3A, the domestic bank 16 confirms that the funds were added to the user's card (step 304).

In the embodiment illustrated in FIG. 3B, the OPS 12 then instructs the user 20 to present the card to the merchant 14 (step 306). For example, the OPS application on the user's smartphone may prompt the user 20 to hand the physical card to a cashier, to swipe the card at a POS terminal of the merchant 14, to enter the card number into a webpage of an ecommerce site of the merchant 14, etc.) The user presents the card to the merchant 14 (step 308). In the embodiment illustrated in FIG. 3B, for example, the user 20 hands the merchant 14 the card, which the merchant 14 swipes at a POS terminal (step 310).

In the embodiment illustrated in FIG. 3B, the merchant's system typically contacts the domestic bank 16 to verify there are sufficient funds / credit limit associated with card (step 312). In this example, the domestic bank 16 verifies that there are sufficient funds/credit limit (step 314) and that the purchase is complete. The funds are then transferred from the domestic bank 16 to the merchant 14. Steps 316, 318, and 320 remaining in FIG. 3B represent a settlement process between the domestic bank 16 and the foreign bank 18, whereby the domestic bank 16 requests the amount of purchase from the foreign bank 18 to reimburse the domestic bank 16 for the funds that it paid to the merchant 14. In one embodiment, this settlement process may involve the OPS 12, but in another embodiment, the settlement process may occur between the domestic bank 16 and the foreign bank 18 without involving the OPS 12 at all. In the embodiment illustrated in FIG. 3B, the OPS 12 notifies the user 20 of the result of the transaction (step 248).

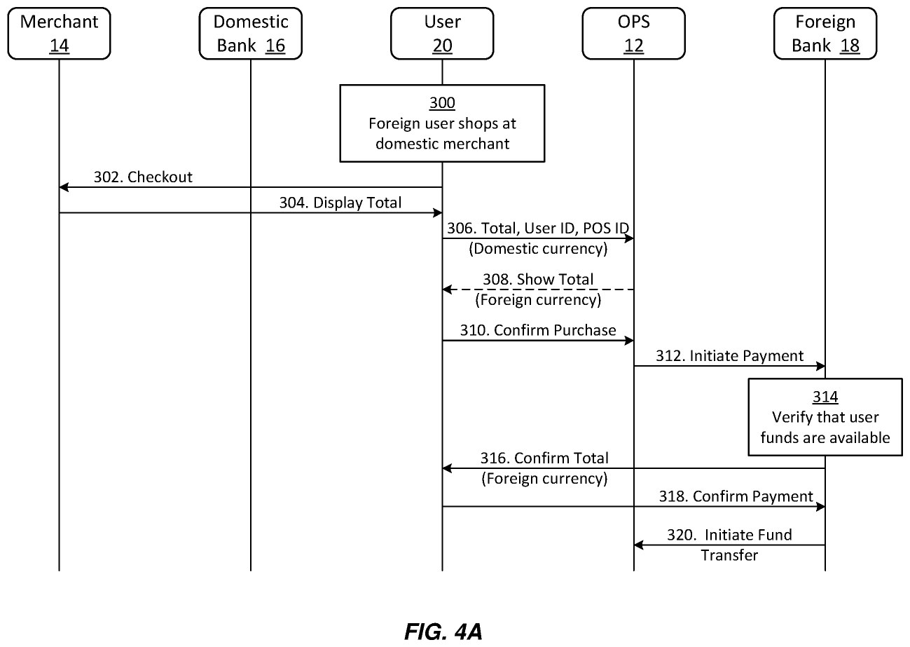

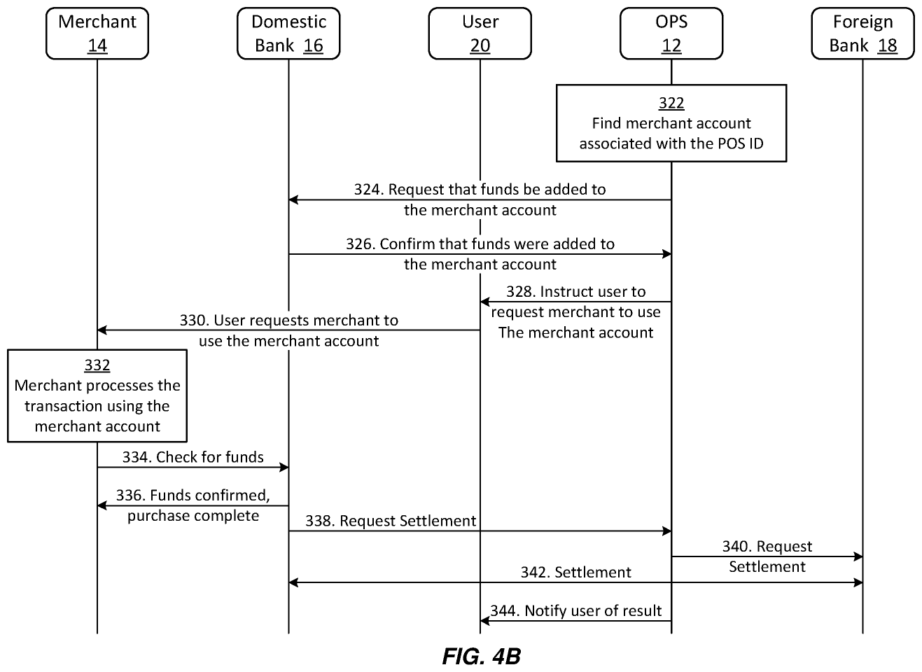

FIG. 4A is diagram illustrating another portion of an exemplary process for providing OPS services according to another embodiment of the present disclosure, where a Merchant's Card or Account is used. FIG. 4A illustrates an interaction between a merchant 14, a domestic bank 16, a user 20, an OPS 12, and a foreign bank 18, such as the like-numbered entities shown in FIGS. 1 A and 1B and described above.

In the embodiment illustrated in FIG. 4A, the Domestic Bank 16 maintains a merchant account and may optionally issue a physical Merchant Card for use by the merchant, not the user, as will be explained below. The OPS 12 maintains an association between a Point Of Sale (POS) terminal ID (or any other type of merchant equipment) and the merchant account.

At step 300, the user 20 begins to shop, e.g., at a physical or online store of the merchant 14. In the embodiment illustrated in FIG. 4A, when the user initiates checkout (step 302), the merchant 14 will display, present, or otherwise provide (which will hereinafter be referred to simply as “present” or “display”) the total to the user 20 (step 304) in the domestic currency.

At step 306, the user 20 communicates the total in the domestic currency, as well as some information that identifies the POS or other merchant equipment, to the OPS 12. In one embodiment, the user 20 enters the total into the OPS application on their smartphone. In one embodiment, the user scans a QR code displayed by the merchant or the POS terminal; the QR code contains the POS ID or other identifier of a merchant equipment. In other embodiments, this information may be obtained via manual entry, scanning or text or bar codes, via wireless communication with the POS or other merchant equipment, etc. In some embodiments, the local payment system being supported by the merchant could be automatically recognized by the OPS 12 through data received from a user mobile or social application, or from a PC, e.g., a QR code read by the user's mobile or social app as displayed by the local merchant. In the embodiment illustrated in FIG. 4A, the OPS 12 will display to the user 20 the total in the foreign currency, e.g., in the currency that the user 20 is familiar with (step 308).

In one embodiment, if the user 20 decides to complete the purchase, the user 20 may notify the OPS 12 by sending a instruction or request to confirm the purchase (step 310), e.g., by tapping on a “confirm purchase?” button on the OPS application or other means. In one embodiment, upon receiving the confirmation in step 310, the OPS 12 will initiate a request for payment from the foreign bank 18 (step 312). In the embodiment illustrated in FIG. 4A, the foreign bank 18 verifies that the user 20 has sufficient funds in his or her account (step 314), and if so, will display to the user 20 the final total for the transaction, which may include additional transaction or processing fees, taxes, or other fees (step 316). In the embodiment illustrated in FIG. 4A, the user 20 then confirms payment (step 318), after which the foreign bank 18 will initiate a fund transfer. In the embodiment illustrated in FIG. 4A, the foreign bank 18 transfers funds, e.g., the payment amount, to the OPS 12 (step 320). In one embodiment, the OPS 12 acts as an intermediary or escrow between the foreign bank 18 and the domestic bank 16/merchant 14. This process continues in FIG. 4B.

FIG. 4B is diagram illustrating another portion of an exemplary process for providing OPS services according to another embodiment of the present disclosure, where a User's Card is used. FIG. 4B illustrates a continued interaction between the merchant 14, the domestic bank 16, the user 20, the OPS 12, and the foreign bank 18.

In the embodiment illustrated in FIG. 4B, the OPS 12 finds a merchant account that is associated with the POS ID or other merchant equipment (step 322), and then issues a request to the domestic bank 16 (step 324) to add funds to the identified merchant account (e.g., if there is a Merchant Card which is a prepaid card) or to set the credit limit of that card (e.g., if there is a Merchant Card which is a credit card) sufficient to cover the payment amount (i.e., the total purchase amount). In one embodiment, the added funds or allowed credit limit may be set to exactly the total purchase amount. In the embodiment illustrated in FIG. 4A, the domestic bank 16 confirms that the funds were added to the merchant account (step 326).

In the embodiment illustrated in FIG. 4B, the OPS 12 then instructs the user 20 to request the merchant to use the identified merchant account (step 330). For example, the OPS application on the user's smartphone may display a QR code or other form of data that identifies the merchant account and prompt the user 20 to show the QR code to the merchant who then scans the QR code and uses the merchant account so identified. The merchant then processes the transaction using the merchant account (step 332).

In the embodiment illustrated in FIG. 4B, the merchant's system typically contacts the domestic bank 16 to verify there are sufficient funds / credit limit associated with merchant account (step 334). In this example, the domestic bank 16 verifies that there are sufficient funds/credit limit (step 3336) and that the purchase is complete.

Steps 338, 340, and 342 remaining in FIG. 4B represent a settlement process between the domestic bank 16 and the foreign bank 18, whereby the domestic bank 16 requests the amount of purchase from the foreign bank 18 to reimburse the domestic bank 16 for the funds that it paid to the merchant 14. In one embodiment, this settlement process may involve the OPS 12, but in another embodiment, the settlement process may occur between the domestic bank 16 and the foreign bank 18 without involving the OPS 12 at all. In the embodiment illustrated in FIG. 4B, the OPS 12 notifies the user 20 of the result of the transaction (step 344).

The process illustrated in FIGS. 4A and 4B and described above has the advantage that the user does not need to possess a physical card. In some embodiments, the merchant may process the transaction by swiping a Merchant Card that is available at the point of sale for that purpose. In other embodiments, the merchant may process the transaction without swiping a card at all. In this manner, legacy credit card/debit card processing infrastructure can be used without any modification.

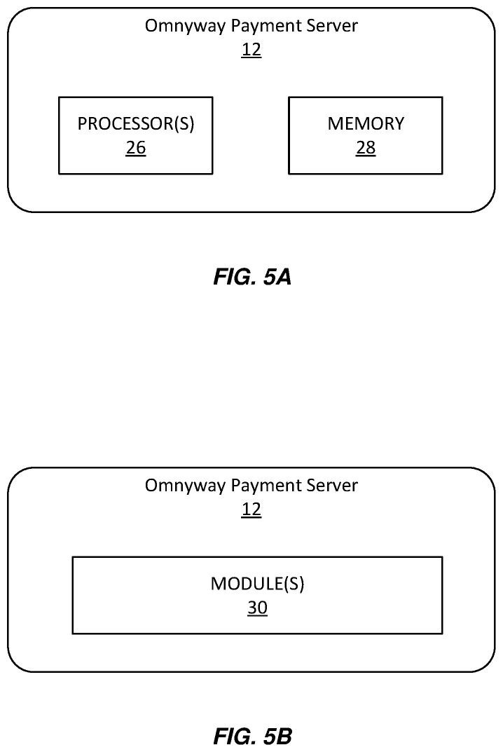

FIG. 5A is block diagram illustrating an exemplary payment server for providing OPS services according to another embodiment of the present disclosure. In the embodiment illustrated in FIG. 5A, a payment server 12, which may be an Omnyway Payment Server (OPS), comprises one or more processors 26 and memory 28 comprising instructions executable by the at least one processor whereby the payment server is configured to: receive first information associated with a desired transaction, the information comprising information identifying a user and an amount; send, to a first financial entity, a request to authorize the desired transaction, the request comprising information for identifying the user and the amount; receive, from the first financial entity, authorization of the desired transaction, the authorization comprising information identifying the user; determine a payment instrument or financial account to be involved in the transaction; send, to a second financial entity, a request to prepare the payment instrument or financial account for the desired transaction; receive, from the second financial entity, a result of that request; and send, to the identified user, an instruction to initiate the desired transaction.

FIG. 5B is block diagram illustrating an exemplary payment server for providing OPS services according to another embodiment of the present disclosure. In the embodiment illustrated in FIG. 5B, a payment server 12 comprises one or more modules operable to: receive first information associated with a desired transaction, the information comprising information identifying a user and an amount; send, to a first financial entity, a request to authorize the desired transaction, the request comprising information for identifying the user and the amount; receive, from the first financial entity, authorization of the desired transaction, the authorization comprising information identifying the user; determine a payment instrument or financial account to be involved in the transaction; send, to a second financial entity, a request to prepare the payment instrument or financial account for the desired transaction; receive, from the second financial entity, a result of that request; and send, to the identified user, an instruction to initiate the desired transaction.

### EXAMPLE #1

### WeChat

WeChat™ is a master application that can host applications, which can likewise host other applications, or “apps within apps”. In other words, WeChat™ operates like an extensible framework. In one embodiment, WeChat™ hosts an Omnyway™ application or subscription, which the Chinese traveler downloads into or subscribes to in WeChat™ prior to leaving China, or on their arrival in the destination country. In one embodiment, the Omnyway™ application may contain special offers and promotions targeted to particular cities, destinations, and/or stores.

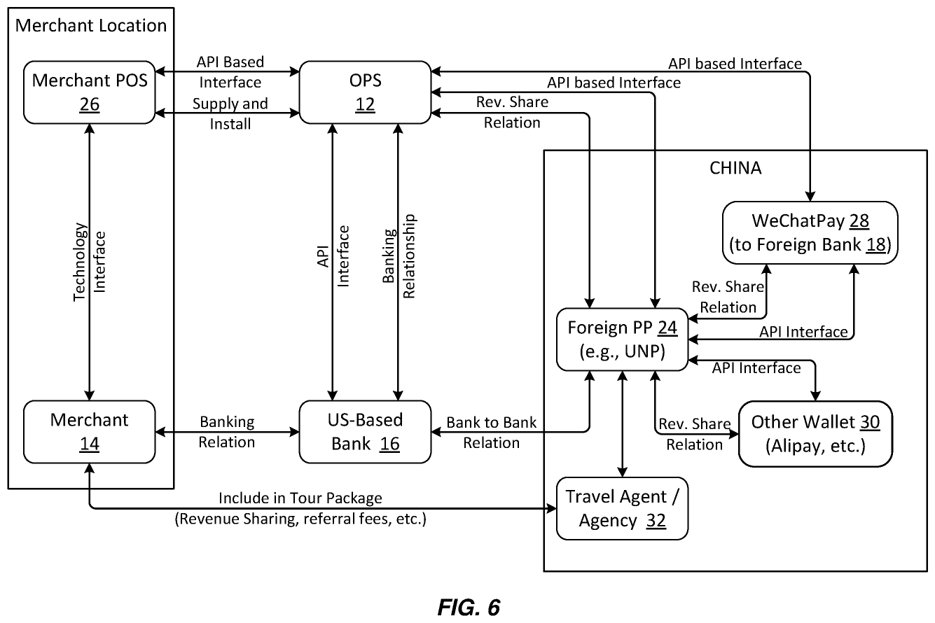

FIG. 6 illustrates an embodiment of the present disclosure in which payment functions are handled by the WeChat™ application, e.g., using WeChat™ Application Programming Interface (API) functions. The traveler may alternatively be referred to as “the user” (of the Omnyway™ application). FIG. 6 shows the various relationships that may exist among the parties, including but not limited to banking relationships, revenue sharing relationships, providing or using API functions, etc. Examples of banking relationships include, but are not limited to, participation in transaction fee sharing, with or without prepaid processing. Examples of revenue sharing relationships include, but are not limited to, sharing of transaction fees, receiving a percentage of sales as an affiliate, etc.

In the embodiment illustrated in FIG. 6, the system includes an Omnyway™ OPS 12, a merchant 14, a domestic bank 16, a foreign bank 18 (not shown in FIG. 6), and a foreign payment scheme/processor 24, which are similar to the like-numbered elements of FIGS. 1A and 1B, and therefore their descriptions are not repeated here. In the embodiment illustrated in FIG. 6, the merchant location includes a merchant POS 26. In the embodiment illustrated in FIG. 6, the foreign payment scheme/processor 24 may be an entity such Union Mobile Financial Technology (UMF), which is a Chinese processor that has an interface into WeChat™.

In the embodiment illustrated in FIG. 6, a WeChatPay™ payment infrastructure 28 (which may also referred to herein as “WeChatPay™ 28”, “WeChat 28”, or simply “payment infrastructure 28”) acts as an interface to banks, such as to the foreign bank 18. The system may also support electronic wallets 30, such as AliPay™, etc.

FIG. 6 illustrates the various relationships that may exist among the parties, including but not limited to banking relationships, revenue sharing relationships, providing or using API functions, etc. In the embodiment illustrated in FIG. 6, a travel agent/travel agency/tour operator/tour guide/tour leader/tour promotor/individual promotor/tour host/tour coordinator/etc. 32 (which may also be referred to herein as “travel agent 32”) may take an active role in the processes and services provided by the OPS 12. For example, the travel agent 32 may encourage tourist users to sign up for OPS services and/or may encourage tourists to visit certain merchants, such as the merchant 14.

The operation of the system illustrated in FIG. 6 to provide Global Traveler Payments (GTP) services will now be described with reference to FIGS. 6A through 6J, which represent example steps of the processes described in FIGS. 2A, 2B, 3, and 4, including examples of information that may be provided to the user 20 via his or her smartphone, performed within the context of the system shown in FIG. 6. Although the examples illustrated in FIGS. 6A through 6J illustrate GTP services, the subject matter is not so limited; GTP services are merely one aspect of the functionality of the methods and systems disclosed herein.

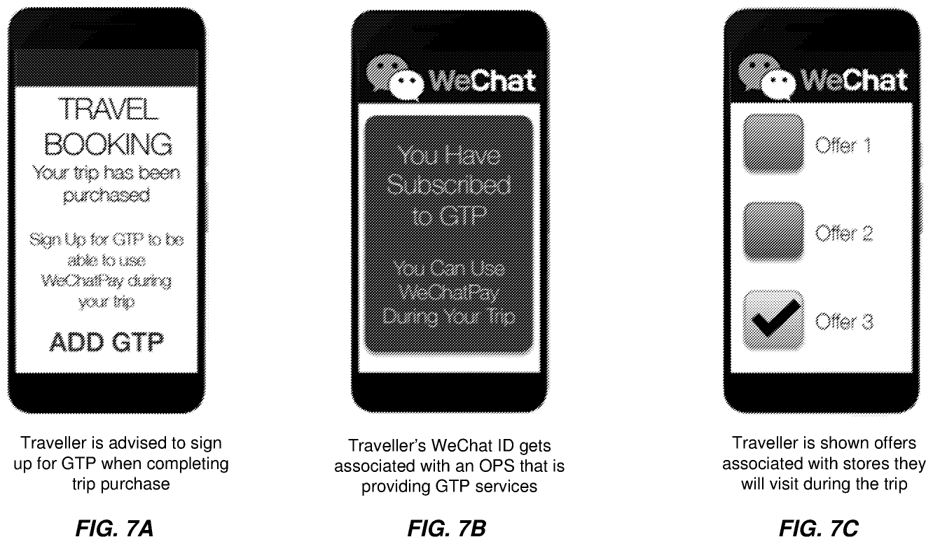

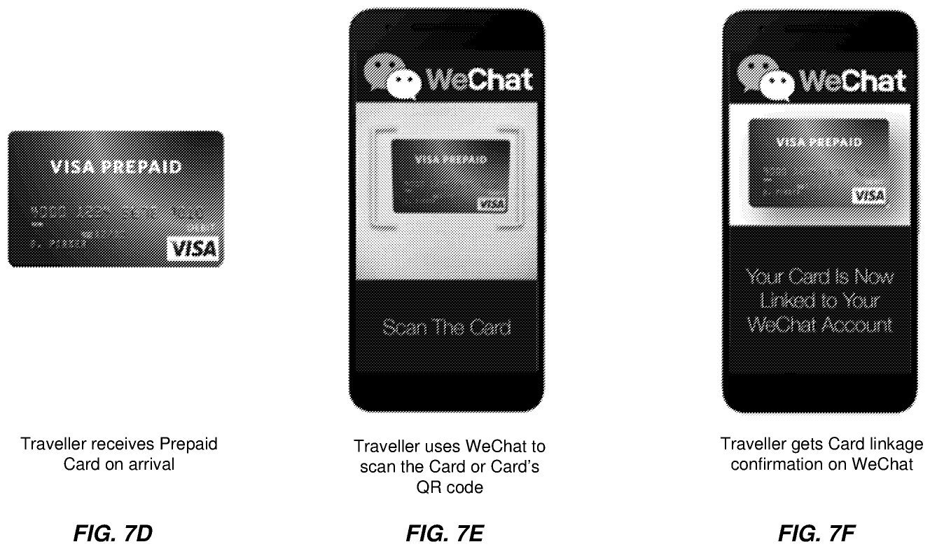

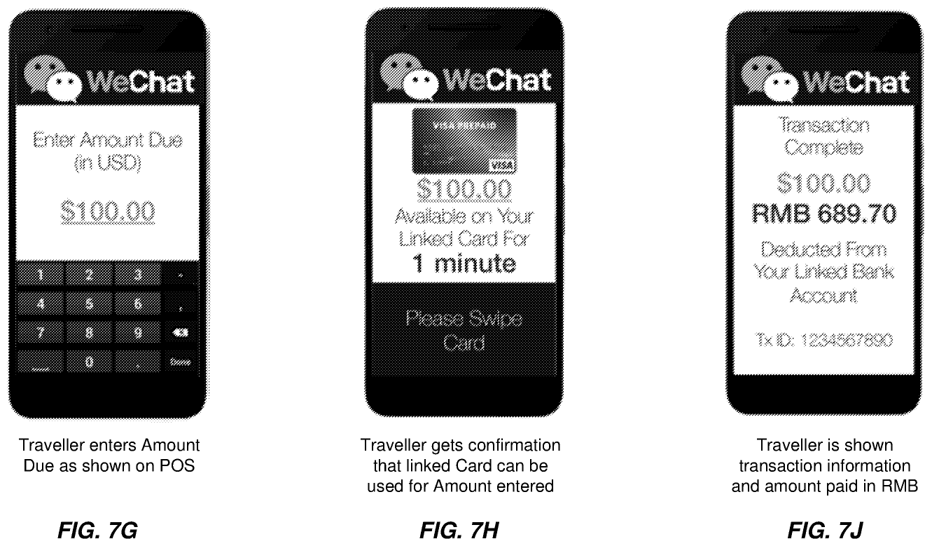

FIG. 7A shows a screen prompting the user 20 to sign up for the GTP service. Should the user 20 opt to do so, e.g., by tapping the “Add GTP” text or button at the bottom of FIG. 7A, this will cause the smartphone to issue a subscribe message, such as message 100 in FIGS. 2A and 2B. In one embodiment, the travel agent 32 may provide this sign-up opportunity to the user 20 or may make the user 20 aware of the GTP service, e.g., as part of a travel package. The travel agent 32 may have an arrangement with the merchant 14 to receive some benefit for including, for example, scheduled trips to the merchant 14 in the tour packet. Such benefits might include referral commissions, free upgrades, free items/services, discounted items / services, etc.

FIG. 7B shows a screen notifying the user that he or she has subscribed to the GTP service. In one embodiment, this is in response to receiving a result message, such as message 106 in FIG. 2A and 2B.

FIG. 7C shows a screen displaying offers and incentives to the user, which may have been provided to the user 20 by the server providing GTP services (e.g., OPS 12), such as via message 108 in FIGS. 2A and 2B. The OPS 12 may take into account user 20 profile information, preferences, destinations, dates, tour type, merchant 14 promotions, travel agent 32 promotions/commissions, etc., when sending these offers and incentives. User 20 will have the option to select, favorite, search, delete, or otherwise interact with these offers to fit their personal preferences or to get more details.

FIG. 7D shows an example prepaid card that the user 20 may receive upon arrival, such as step 200 in FIG. 3A. The card may be a prepaid card, a credit card, or some other bank card or financial transaction instrument. Although the examples describe a process that uses a physical card, a virtual card may also be used, or the OPS 12 could allow for a direct connection to the merchant 14 or the merchant POS 26 via a digital link, and handle the card transaction online or via ecommerce channels. In one embodiment, the user will be given a physical credit card with a unique number. In one embodiment, this may be done upon arrival at the destination (in this example, the US); in another embodiment, this may be done prior to departure.

FIG. 7E shows a screenshot of a user 20 scanning or taking an image of the physical card as part of the process of associating the card with the user's GTP account. Scanning the card can include, but is not limited to, scanning the unique card Primary Account Number (PAN), alternate card ID, card barcode, or card QR code, and may include accessing the card via a Near Field Communication (NFC) or other contactless interface, etc. In one embodiment, when the user receives the physical card, the user enters the card number into the Omnyway™ application/subscription to link the user (or the user's instance of the Omnyway™ application/subscription) to the physical card. In one embodiment the GTP application or other application on the user's smartphone may communicate information to the OPS 12 for the purpose of associating the card to the user's GTP account, such as in step 202 in FIG. 3A.

FIG. 7F shows an example notification that may be sent to the user 20 to indicate that the card was associated with the user's GTP account. FIGS. 6E and 6F illustrate the point that, in some embodiments, the association of the user's card with the GTP account may be via an interaction with some entity, such as the foreign bank 18, the foreign payment scheme/processor 24, or both. In other embodiments, the association of the user's card with the GTP account may involve an interaction with the OPS 12 only or in concert with other entities.

Once in the destination country, if the user wants to make a purchase, in one embodiment, the user shows the app to the retailer so that the retailer can scan the information that is presented by the app to the retailer. Example information includes, but is not limited to, discounts, special offers, coupons, other incentives, or other information that may be pertinent to the transaction. In one embodiment, the retailer then provides a (potentially discounted) total to the user. The user enters the total into the Omnyway™ application.

FIG. 7G shows a screenshot of a user 20 entering the amount of the transaction that was provided by the merchant 14, such as steps 208 and 210 in FIG. 3A. In one embodiment, the Omnyway™ application passes the information to the WeChat™ processing system 28. The WeChat™ backend authorizes the transaction, i.e., confirms that the funds are available in the user's account. If sufficient funds are available, the WeChat™ backend generates an approval.

FIG. 7H shows an example notification to the user 20 that the amount of purchase will be available on the linked card, such as in step 306 of FIG. 3B. In one embodiment, the approval includes a QR code that is displayed to the user and retailer by the Omnyway™ application and is scanned by the POS to prove completion. In one embodiment, the amount of purchase will be available to the linked card for a limited window of opportunity. In one embodiment, upon approval, the Omnyway™ application would instruct the user to hand over to the retailer the credit card that was previously linked to the user as described above. In the embodiment shown in FIG. 7H, for example, the user has only 1 minute to present the card to the merchant, such as step 308 in FIG. 3B.

FIG. 7J shows an example notification to the user 20 that the transaction is complete. In the embodiment illustrated in FIG. 7J, the user 20 is shown the transaction amount in domestic currency (e.g.,100 USD), the amount in foreign currency (e.g., 689.70 RMB), and a transaction ID (e.g., “1234567890”) for future reference, if needed.

In one embodiment, Omnyway™ will work with the domestic bank that issues the physical cards, e.g., domestic bank 16. In one embodiment, the OPS 12 captures the card swipe information (card number, merchant ID, terminal ID, and/or total amount, etc.) from the merchant POS 26 and transfers this to information to the domestic bank 16 via a payment network such as the Visa™, Discover™, or MasterCard™ network. This US portion of the transaction goes through the normal authorization process to verify that the user has sufficient funds. In one embodiment, the domestic bank 16 will have created the equivalent of a prepaid card for the exact amount, in which case the domestic bank 16 will respond to the authorization request with an indication that there is enough money in the account. In this manner, the OPS 12 operates to create an instant account on the card. Once the domestic bank 16 processes the authorization, the exact amount is removed from the card, and the card will again have no value.

In one embodiment, during settlement, funds are moved from the user's account to an intermediary account that is controlled by Omnyway™, which may be an account in the user's home country, the country being visited, or in another country. In the above example, funds may be moved from the Chinese tourist's account to a bank account in a Chinese bank.

### EXAMPLE #2

### ADYEN

In the embodiments described above, WeChat™ operates as the front-end to the foreign bank(s) 18. In another embodiment, an additional entity may operate as an intermediary between the OPS 12 and various payment infrastructures. An example of such an entity is ADYEN™, which provides a unified API to backend payment processors such as WeChat™, AliPay™, Visa·8, Discover™, and others. In such embodiments, the foreign payment scheme/processor 24 in FIG. 6 may be an ADYEN™ server. In such embodiments, the OPS 12 may have arrangements with multiple payment infrastructures and may use the ADYEN™ API to communicate with the various payment infrastructures. Using a unified API to communicate with various payment infrastructures simplifies the design of the system and software as well as the design of the Omnyway™ application on the user's smartphone.

### EXAMPLE #3

### WeChat or AliPay

In yet another embodiment, the OPS 12 may be configured to use different payment infrastructures, and optionally use different payment infrastructures for different purposes. For example, in one embodiment, the OPS 12 may be configured to provide a front-end prepaid card and a backend payment via either WeChat™ or AliPay™. In one embodiment, the user may use an Omnyway™ smartphone application to select whether to use WeChat™ or AliPay™, which determines which backend settlement process to use.

### EXAMPLE #4

### Social/Mobile/Real Time ACH Payment

In yet another embodiment, the OPS 12 may be configured to work with new generation of Social payment, Mobile payment, or Real Time ACH payment infrastructure that is not integrated with a traditional payment acceptance infrastructure within a country, where the user could be a local resident besides a Traveler from another country. For example, in one embodiment, the OPS 12 may be configured to provide a front-end foreign or local issued prepaid, credit, or debit (physical and/or virtual) card and a backend payment via either Zelle™ or Venmo™ in the United States, PayMe™ in Hong Kong, Faster Payments in UK, and IMPS or Pay™ in India, WeChat Pay or AliPay in China, and additional new generation payments in same or other countries. For example: US residents, tourists or visitors can use a third party or social media mobile app or a personal computer to make payments at Chinese merchants using payment mechanisms already extant in China. Such a transaction may take place at a backend server inside or outside of China (via Visa, Mastercard, Discover, Venmo, or other payment schemes) while the Chinese merchant is paid in RMB, with no change required at the merchant's Point Of Sale (POS) front-end or eCommerce site. In one embodiment, the user may use an Omnyway™ smartphone, social or bot application to select whether to use Zelle℠ or Venmo™ in United States, PayMe™ in Hong Kong, Faster Payments in UK, IMPS or Pay™ in India, and additional new generation payment systems in same and other countries, which determines which backend settlement process to use.

### Other Configurations

In one embodiment, the card provided to the user 20 is a credit card. In one embodiment, the transaction information is provided to the issuing bank (e.g., the foreign bank 18), which verifies that the user's credit is good (e.g., there is no actual balance on the account). The merchant 14 gets the money during settlement, usually a day later. If the user 20 fails to pay the credit card bill, the issuing bank suffers the loss.

In one embodiment, the card provided to the user 20 is a prepaid card. In one embodiment, the transaction goes to the bank that issued the prepaid card (e.g., the domestic bank 16), which verifies that the prepaid card has an actual balance sufficient to cover the transaction, in which case the transaction is processed and money is transferred from the prepaid card account to the merchant account. If the prepaid card balance is not sufficient to cover the transaction, in one embodiment the domestic bank 16 indicates how much money is available. For example, the merchant 14 may be notified that the card has X amount of funds, and the user 20 should pay the remaining balance of Y by cash or using a different card or financial instrument. In these embodiments, the OPS 12 instantly creates a prepaid card with a specific amount.

In one embodiment, the system is configured to support multiple front-end systems (e.g., prepaid card, credit card, debit card, virtual card, etc.) as well as multiple back-end systems (e.g., ADYEN™, WeChatPay™, AliPay™, Tenpay, Visa™, MasterCard, Discover, American Express, JCB, CUP, Zelle℠, Venmo™, IMPS, PayMe™, Yandex Pay, Pay™, Cartes Bancaires, SEPA direct debit, Giropay, Sofort, iDEAL, Qiwi, JioMoney, BHIM, BACS Direct, Interac, Boleto, Elo, POLi, Carrier Billing, Pay-easy, Konbini, paysafecard, Pay-by-links, Hipercard, etc.)

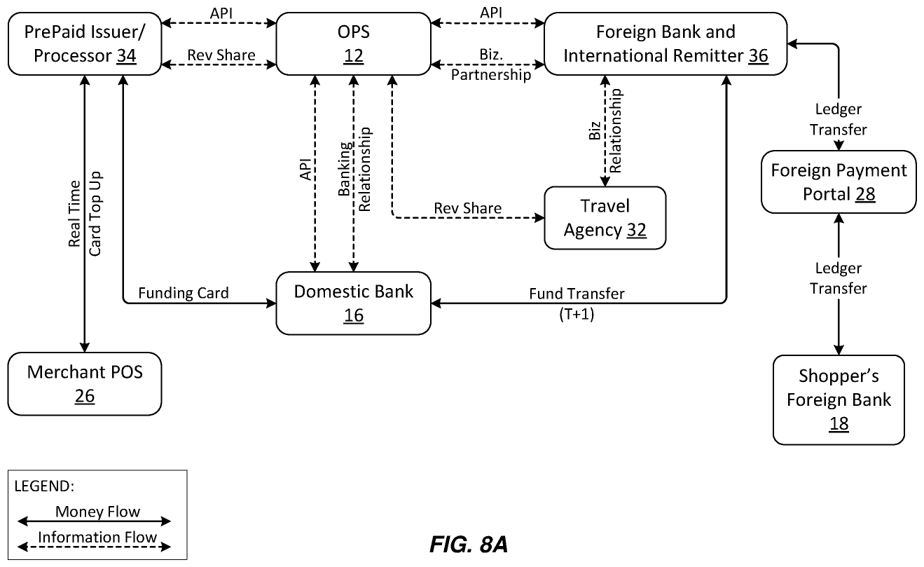

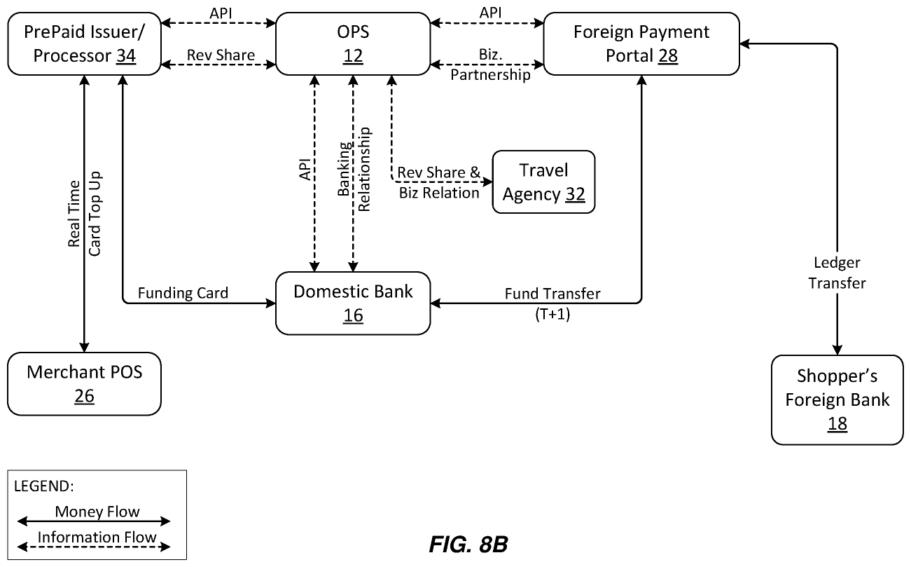

FIG. 8A illustrates another embodiment of the present disclosure, showing the various relationships that may exist among the parties, including but not limited to banking relationships, revenue sharing relationships, providing or using API functions, etc. In the embodiment illustrated in FIG. 8A, the parties include, but are not limited to, the OPS 12, the domestic bank 16, the foreign bank 18, a merchant POS 26, a foreign payment portal 28, and a travel agent 32, the functions of which are essentially identical to the like-numbered elements described in the figures above, and therefore the descriptions of which will not be repeated here. In the embodiment illustrated in FIG. 8A, the system also includes a prepaid issuer/processor 34, which issues and manages prepaid cards, and a foreign bank and international remitter 36, which acts as an intermediary between the OPS 12 and the foreign payment portal 28.

FIG. 8A illustrates an embodiment in which the prepaid issuer/processor 34 is an entity separate from the bank that issued the prepaid card, (e.g., domestic bank 16). In alternative embodiments, the domestic bank 16 may also be the prepaid issuer/processor. In another alternative embodiment, the prepaid issuer/processor 34 may have their own issuing bank separate from the domestic bank 16 that is connected to the OPS 12, and the issuing bank of the prepaid issuer/processor 34 may have a direct bank-to-bank relationship with the domestic bank 16.

FIG. 8A also illustrates an embodiment in which the foreign bank and international remitter 36 is an entity separate from the foreign payment portal 28 and the shopper's foreign bank 18.

FIG. 8B illustrates an alternative to the embodiment shown in FIG. 8A, in which the functions performed by the foreign bank and international remitter 36 may be performed instead by the foreign payment portal 28 and/or the foreign bank 18.

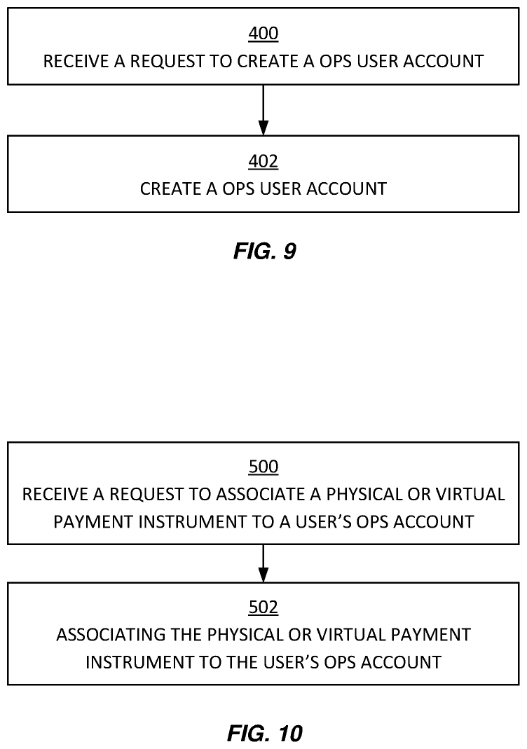

FIG. 9 is a flow chart illustrating an exemplary method for providing a universal, global, virtual-to-physical payment adapter according to an embodiment of the present disclosure. In the embodiment illustrated in FIG. 9, a method of operation of an OPS 12 includes: receiving a request to create an OPS user account (step 400); and creating the OPS user account (step 402).

FIG. 10 is a flow chart illustrating an exemplary method for providing a universal, global, virtual-to-physical payment adapter according to another embodiment of the present disclosure. In the embodiment illustrated in FIG. 10, a method of operation of an OPS 12 includes: receiving a request to associate a physical or virtual payment instrument with a user's OPS account (step 500); and associating the physical or virtual payment instrument with the user's OPS account (step 502). Examples of the physical or virtual payment instrument include, but are not limited to, a credit card, a prepaid card, a debit card, and a virtual credit, prepaid, or debit card.

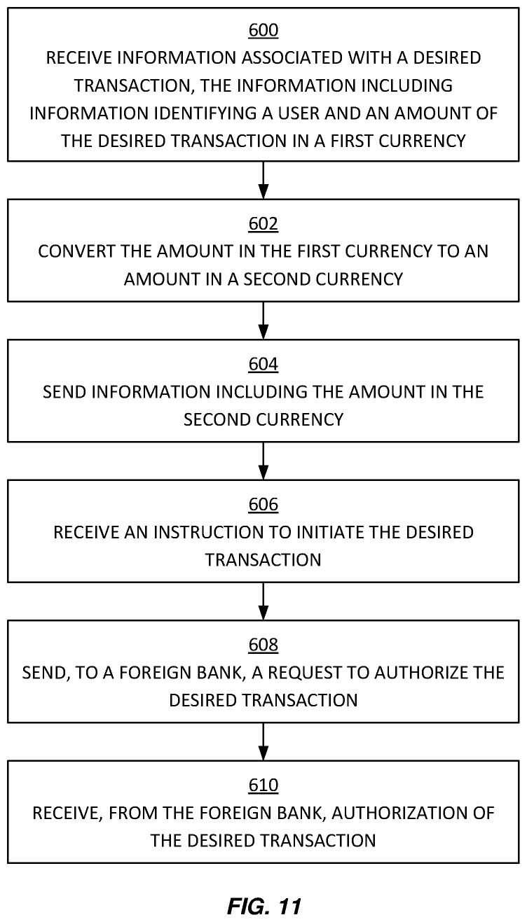

FIG. 11 is a flow chart illustrating an exemplary method for providing a universal, global, virtual-to-physical payment adapter according to another embodiment of the present disclosure. In the embodiment illustrated in FIG. 11, a method of operation of an OPS 12 includes: receiving information associated with a desired transaction (step 600), the information including information identifying a user and an amount in a first currency; converting the amount in the first currency to an amount in a second currency (step 602) and sending information including the amount in the second currency (step 604); receiving an instruction to initiate the desired transaction (step 606); sending, to a foreign bank, a request to authorize the desired transaction (step 608) the request including information for identifying the user and the amount in the second currency; and receiving, from the foreign bank, authorization of the desired transaction (step 610).

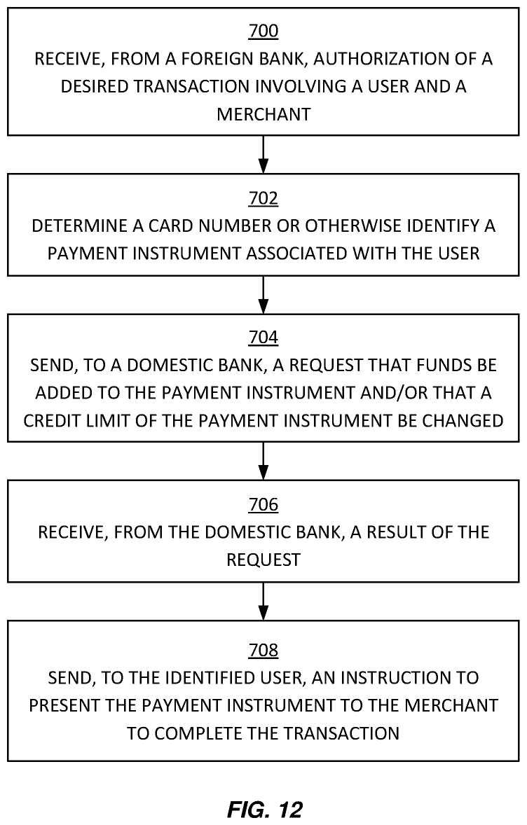

FIG. 12 is a flow chart illustrating an exemplary method for providing a universal, global, virtual-to-physical payment adapter according to another embodiment of the present disclosure. In the embodiment illustrated in FIG. 11, a method of operation of an OPS 12 includes: receiving, from a foreign bank, authorization of a desired transaction involving a user and a merchant (step 700), the authorization including information identifying the user; determining a card number or otherwise identifying a payment instrument associated with the identified user (step 702); sending, to a domestic bank, a request that funds be added to the payment instrument and/or that a credit limit of the payment instrument be changed (step 704); receiving, from the domestic bank, a result of that request (step 706); and sending, to the identified user, an instruction to present the payment instrument to a merchant involved in the desired transaction (step 708).

### User Card

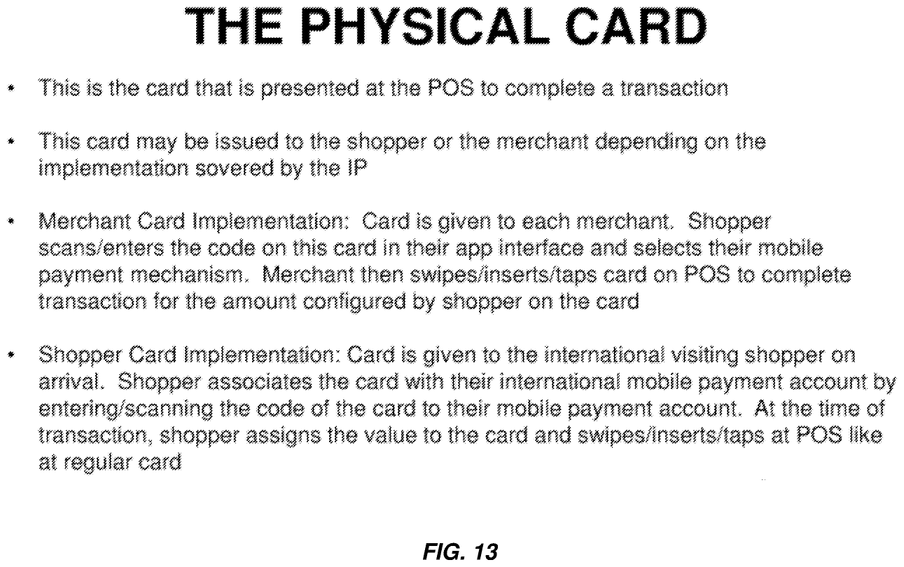

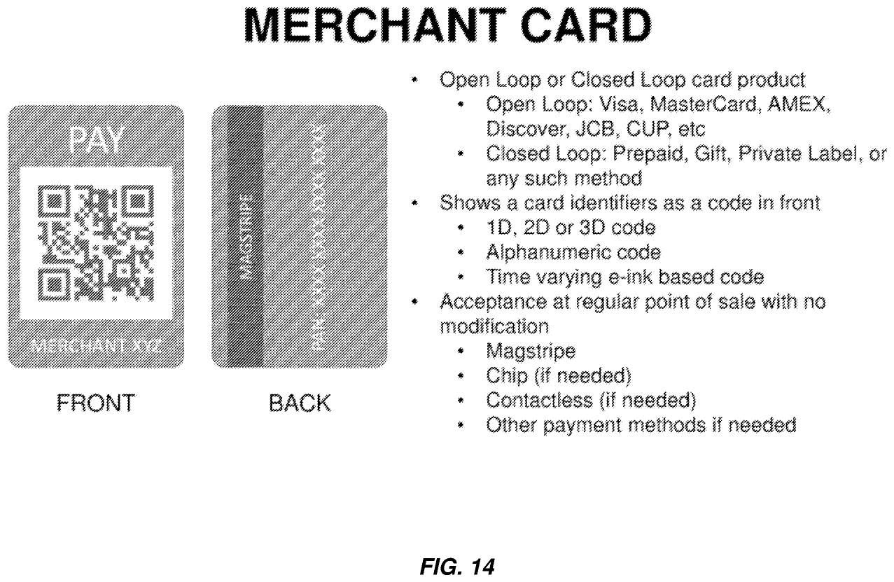

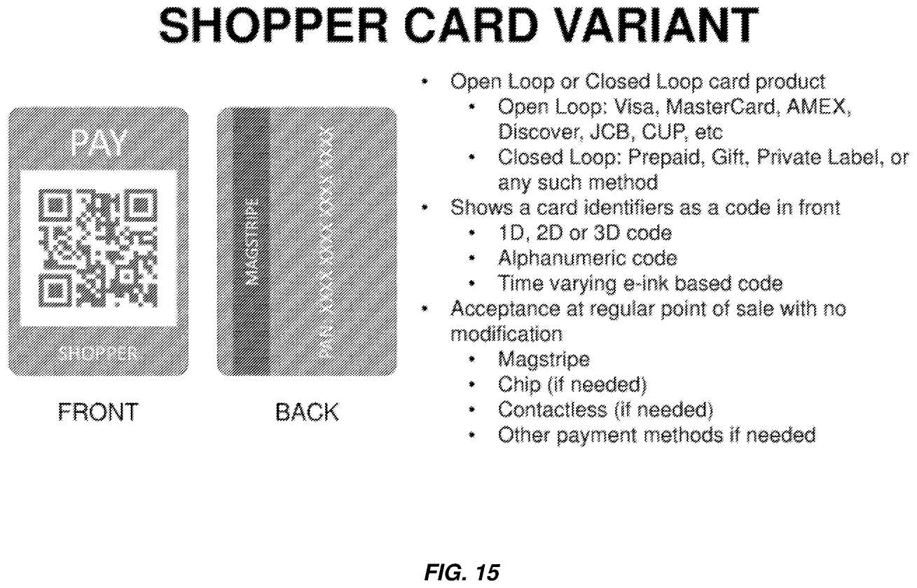

FIGS. 13 through 15 illustrate various aspects of the physical card according to different embodiments of the present disclosure. In embodiments which use a physical card, the physical card may be presented at a POS terminal to complete a transaction. In the examples above, a physical card is issued to the user, who presents the card to the merchant for the purchase of making a transaction. In one embodiment, the user may scan a QR code, barcode, etc., which includes information that identifies the merchant and/or POS terminal or other equipment, which is then provided to the OPS 12. The OPS 12 may use this information to identify the card transaction as it is processed by the payment network so that the OPS 12 can notify the user of the result of the transaction, e.g., via the user's mobile phone or other smart device. The step of scanning a QR code, etc., to determine a merchant/POS terminal ID is not required in the User Card embodiments, however, because the card transaction proceeds a usual once the OPS 12 has completed the pre-requisite process of ensuring that the user card has sufficient funds/sufficient credit limit for the desired transaction.

### Merchant Card

In alternative embodiments, however, the merchant may be issued a physical card, which the merchant swipes (or inserts if it is a chip card) on its point of sale system at the time of transaction. In one embodiment, the user may scan or otherwise acquire information (e.g., a QR code) from the merchant's card, which may then be sent to an OPS 12 by, for example, an application on the user's mobile device. Examples of both User Card and Merchant Card implementations may be found FIGS. 13 through 15.

For example, in one embodiment, a customer selects items for purchase and takes them to a POS sale register at merchant premises, and the merchant begins the checkout process. Before, during, or after the checkout process the user receives information, provided by the merchant, that identifies the POS terminal or other equipment (such as a tablet device with hardware that can read information from a credit card) engaged in the checkout process. This information may be a POS terminal ID or other information that identifies the equipment involved in the checkout process or otherwise involved in the commercial transaction. For simplicity of description, the term POS terminal will be used for the remainder of this example, but the subject matter of the present disclosure is not limited to just POS terminals.

In one embodiment, the user may scan a QR code, bar code, or other graphic element using the user's mobile phone. Such information may be displayed by the POS terminal, displayed somewhere else on the merchant premises, or otherwise provided by the merchant via other means, including but not limited to via wired or wireless communication, provided aurally to the user, recited to the user who then enters the information manually, etc. This information is provided to the the OPS 12, e.g., via an application on the user's smart device.

In one embodiment, the OPS 12 uses that information to identify the merchant and/or identify the entity/location of the transaction in progress. In one embodiment, each POS terminal (or other device) is associated with its own credit card/debit card/prepaid card account or other financial account, hereinafter referred to as the “card account” for brevity, in which case the OPS 12 uses the received information to identify the card account associated with the POS terminal as well as financial institution associated with the card account, referred to herein as the “issuing bank”.

The merchant notifies the user of the total, which the user enters into the application, and which the application provides to the OPS 12. The OPS 12 then verifies that the user has sufficient funds or credit in the user's account, and if not, in one embodiment the OPS 12 notifies the user that the transaction is denied.

If the user has sufficient funds or credit limit, in one embodiment, the OPS 12 requests confirmation of the transaction from the user. If needed, the OPS 12 may convert the total from a domestic currency to the user's native currency, which is displayed to the user during the request for confirmation. If the user approves the transaction, the OPS 12 instructs the issuing bank to transfer funds (if a debit card or prepaid card) or increase the credit limit (if a credit card) in an amount sufficient to cover the transaction total.

The OPS 12 then notifies the user to instruct the merchant to “swipe the card”, which may entail actually swiping a physical card maintained by the merchant, or may entail virtually swiping a virtual card via a software process, but in either case is processed like a normal credit/debit/prepaid card transaction using existing systems. The existing payment network processes and approves the transaction, then notifies the OPS 12 of the result, which the OPS 12 provides to the user, e.g., via the user's mobile application.

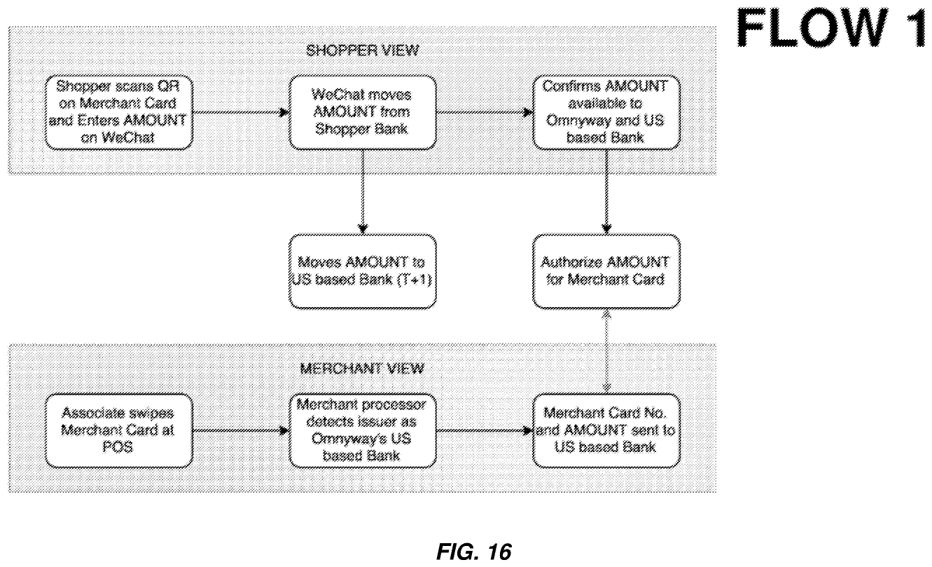

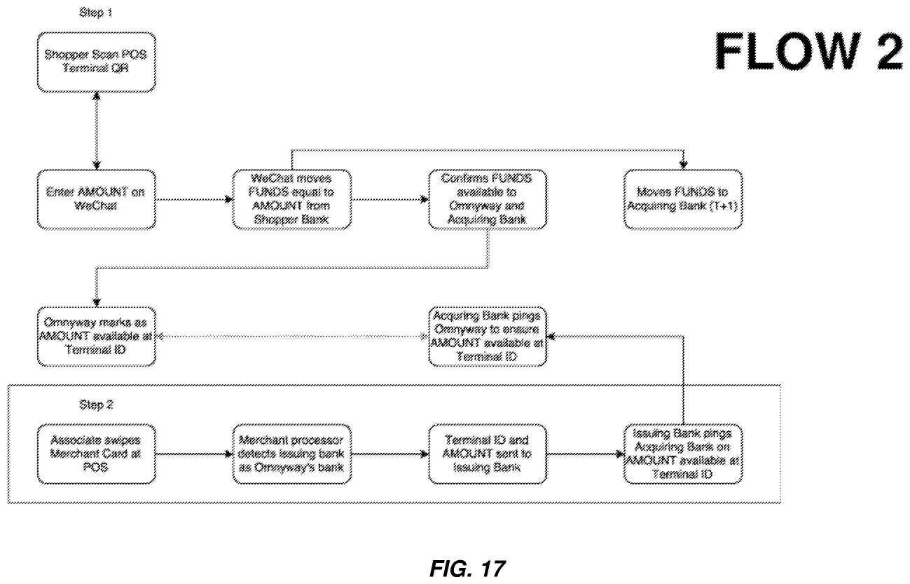

FIGS. 16 and 17 illustrate example flows for exemplary Merchant Card embodiments. In the embodiment illustrated in FIG. 16, the user scans a QR code on the Merchant Card. This then associates the transaction to that specific Merchant Card. When the user commits the payment in the WeChat interface, that Merchant Card gets approved for the amount that the user committed to in WeChat. So when the card is swiped at the POS, the system checks with the Omnyway server for the amount the card that has been swiped is approved for, and gets a confirmation back from the system for that particular merchant card. In the embodiment illustrated in FIG. 17, the QR code is associated with the POS. It can appear as a sticker on the POS, on the POS screen, or any other format that allows for a QR code or any other code that we support to be visible on the POS. The shopper then scans this QR code and approves/commits an amount through the WeChat interface. The system then commits the amount to the POS that was identified through the POS Code. The Merchant Card in this case does not have a QR code on it. The associate swipes the Merchant Card at the POS, and the swipe indicates to the system the Merchant Card number that was swiped. The system commits the pre-approved amount to that Merchant Card in real time, allowing for the transaction to go through.

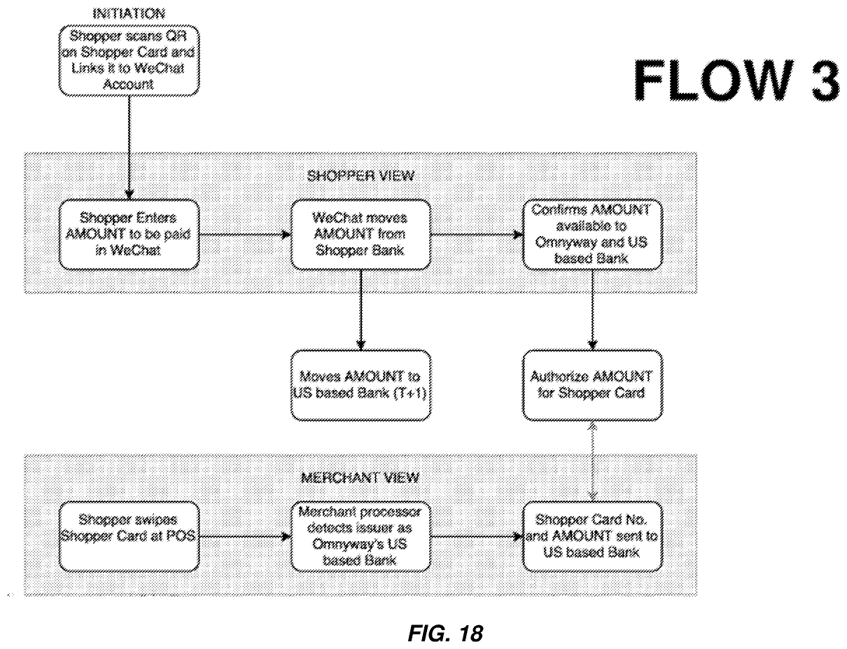

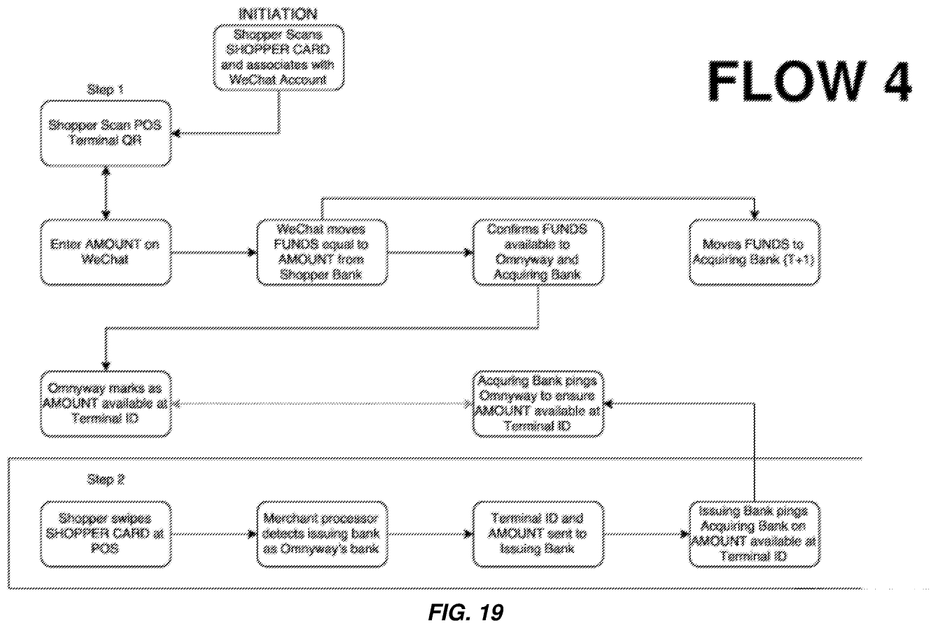

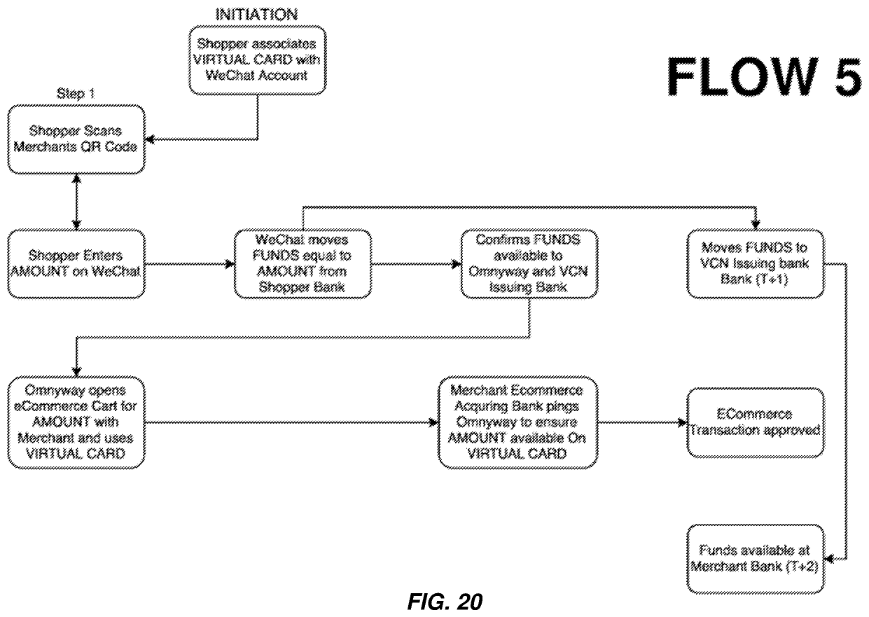

FIGS. 18 through 20 illustrate example flows for exemplary User Card embodiments. The User Card embodiments are similar to the Merchant Card embodiments, one difference being that in the User Card embodiment, the shopper will swipe the card, but in the Merchant Card embodiment, the associate swipes the Merchant Card. Another difference is that, in the User Card embodiment, the system will commit the amount of funds to the Shopper Card, but in the Merchant Card embodiment, the system will commit the amount of funds to the Merchant Card. FIGS. 18 and 19 illustrate exemplary flows using a physical card, and FIG. 20 illustrates an exemplary flow using a virtual card.

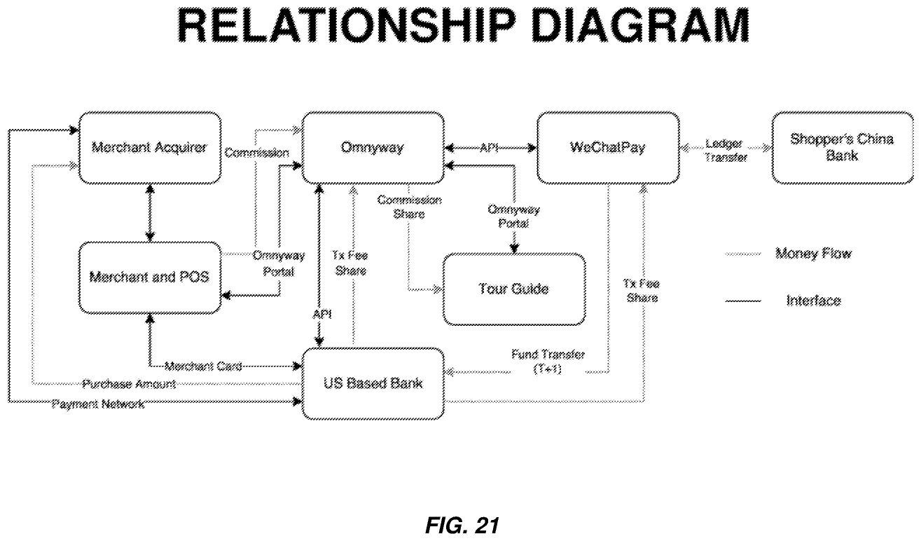

FIG. 21 is a diagram illustrating exemplary relationships between entities engaged in a system for providing a universal, global, virtual-to-physical payment adapter according to another embodiment of the present disclosure.

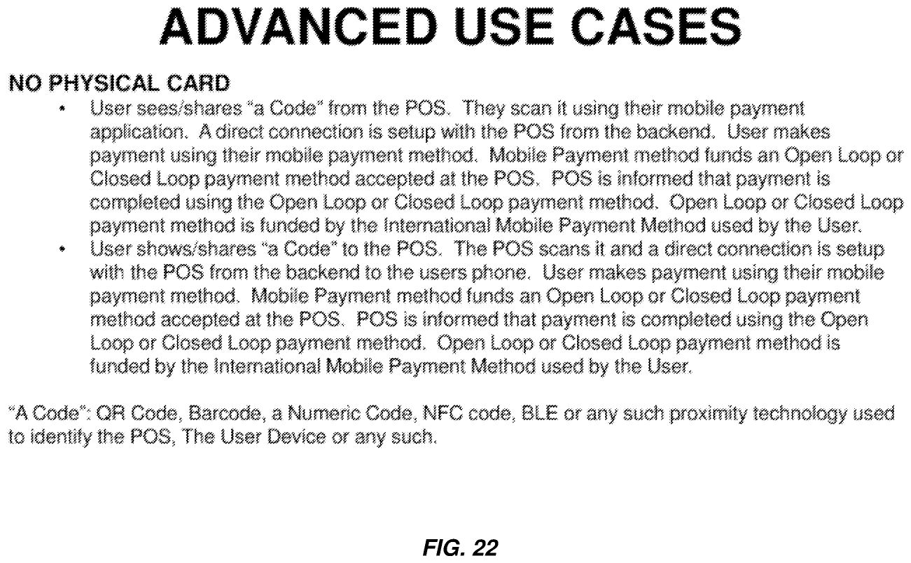

FIG. 22 includes additional information regarding embodiments that use virtual, rather than physical, cards.

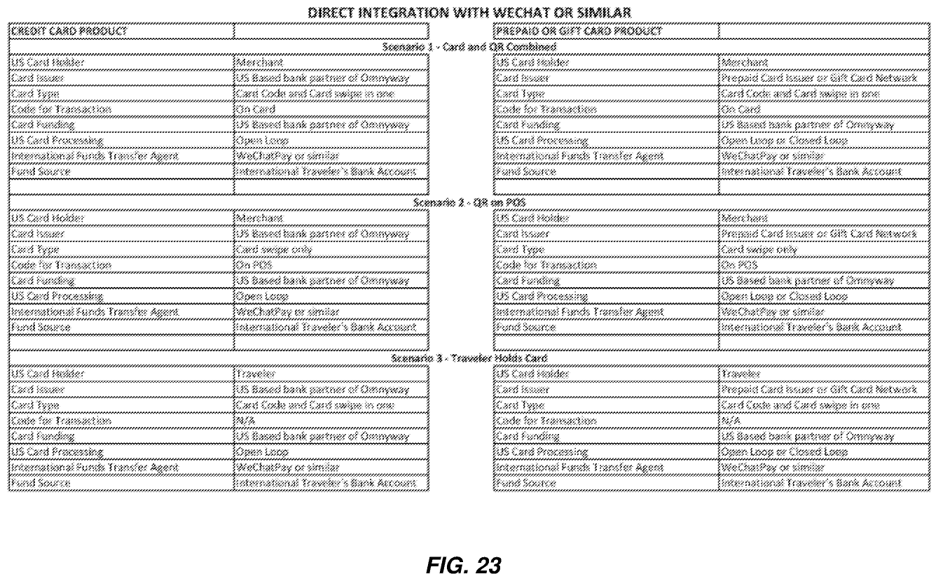

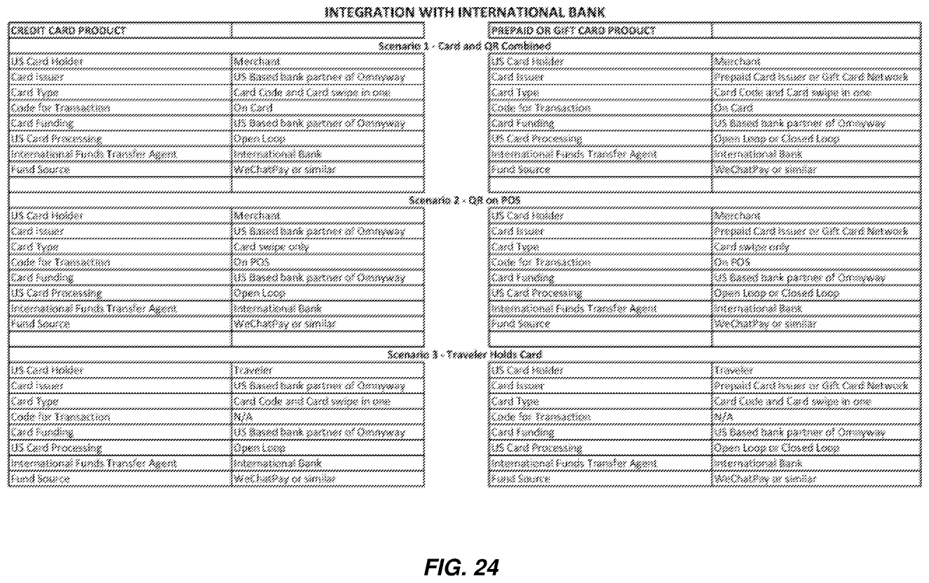

FIGS. 23 and 24 include tables that list roles and exemplary entities that might perform these roles in various scenarios contemplated by the subject matter of the present disclosure. FIG. 23 includes scenarios involving direct integration with Wechat or a similar application/service, and FIG. 24 includes scenarios involving integration with an international bank (rather than through Wechat or similar).

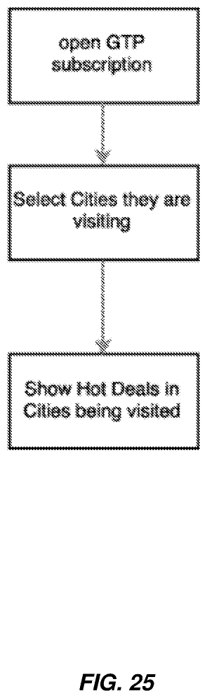

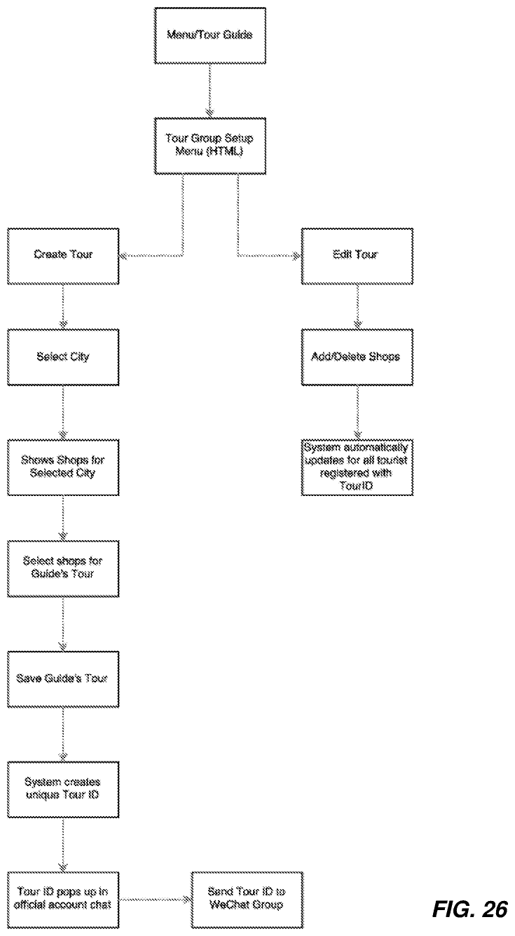

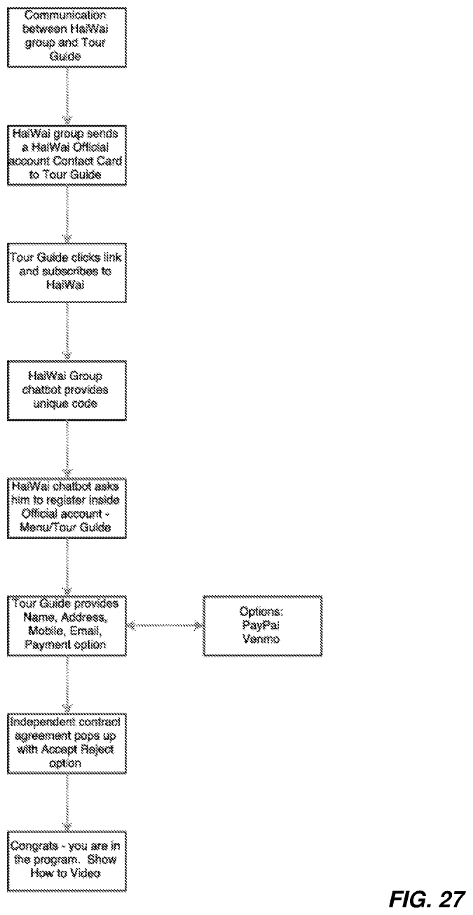

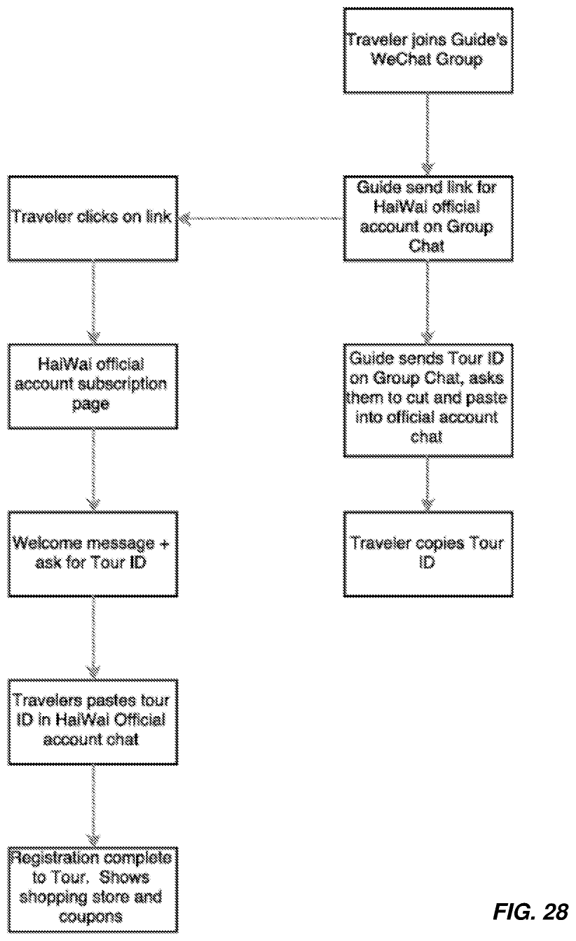

FIGS. 25 through 28 are flow charts illustrating portions of an exemplary process for providing a universal, global, virtual-to-physical payment adapter according to another embodiment of the present disclosure.

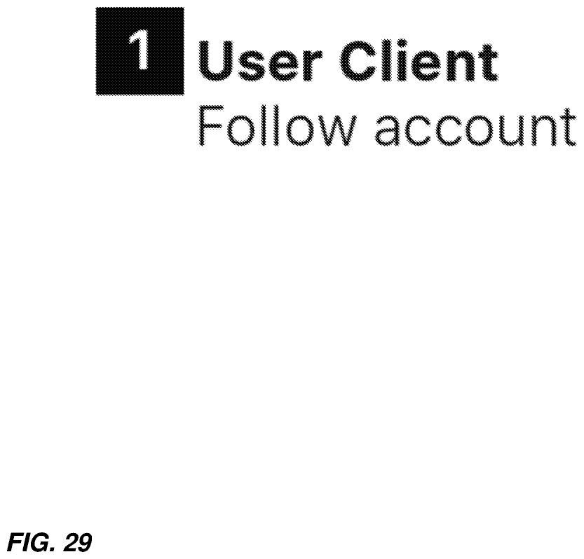

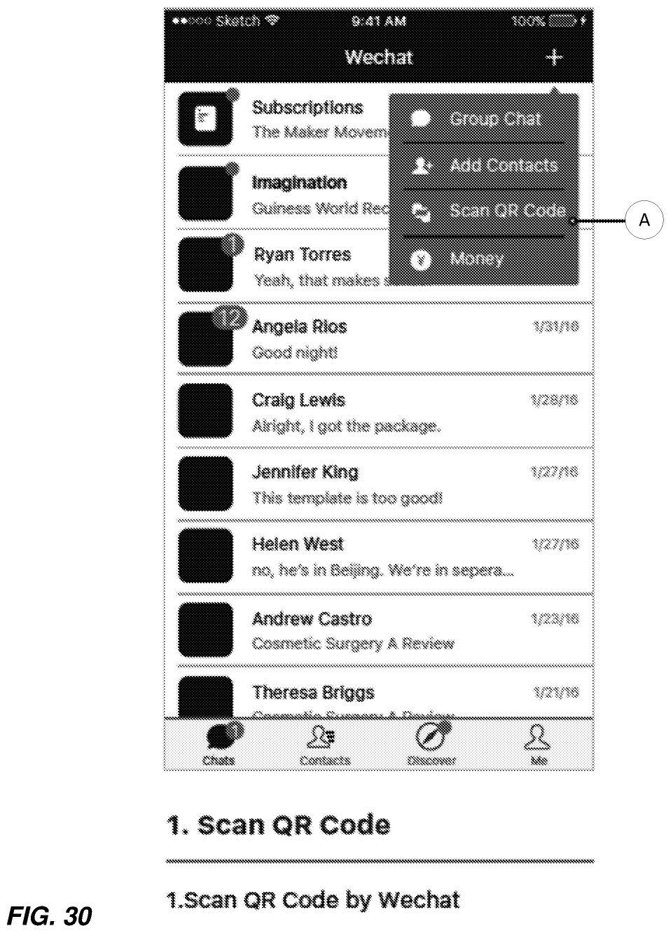

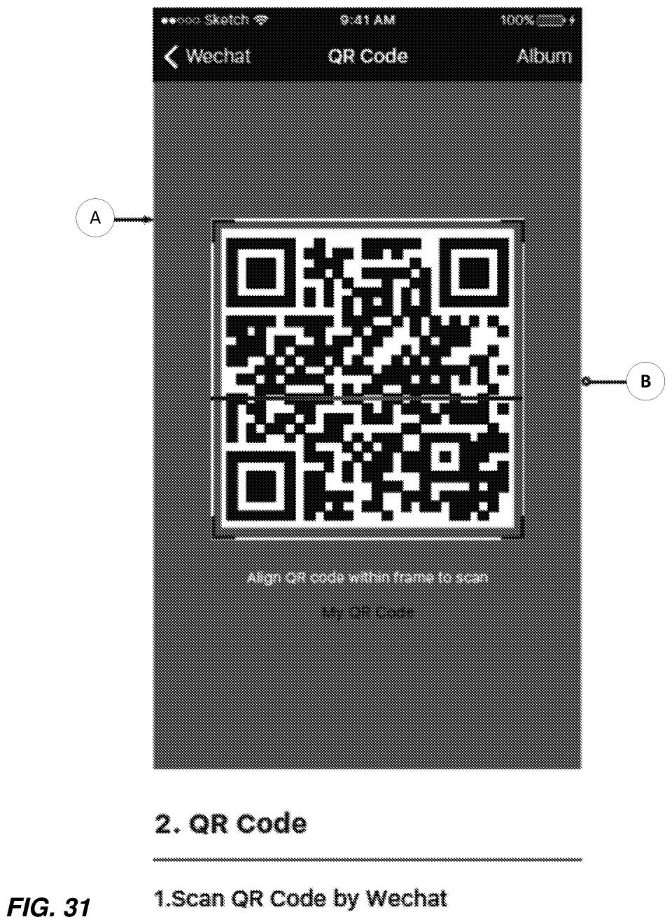

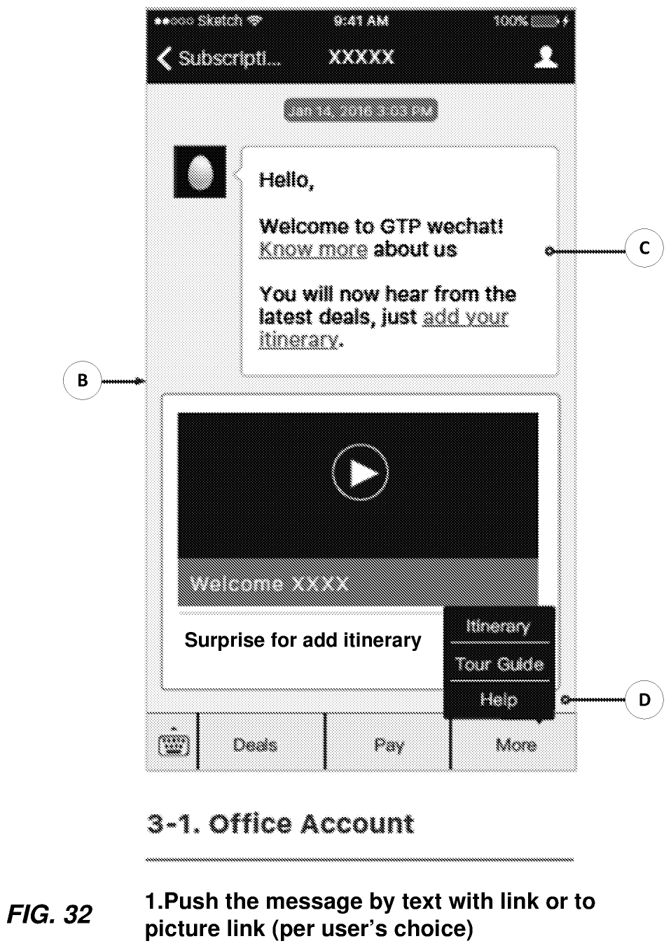

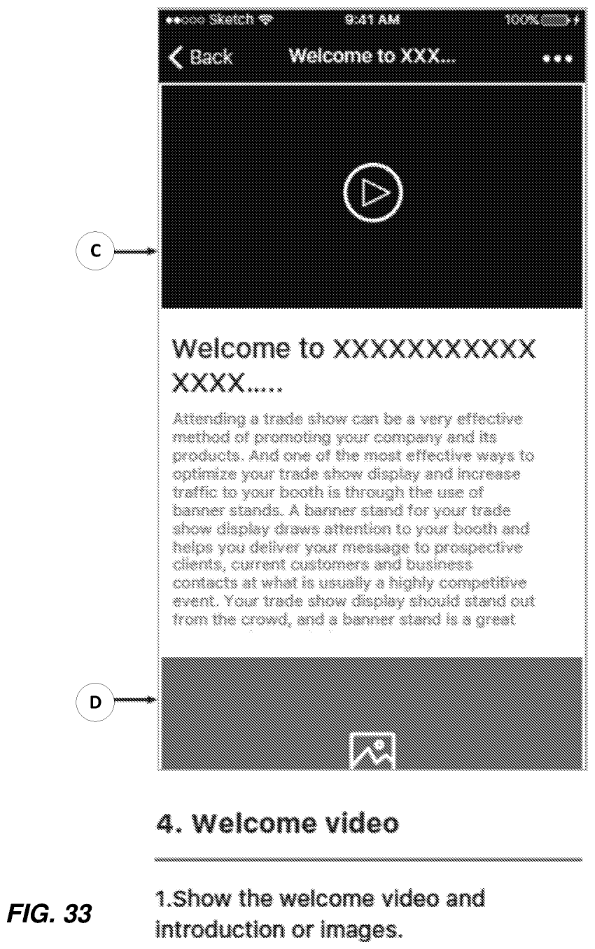

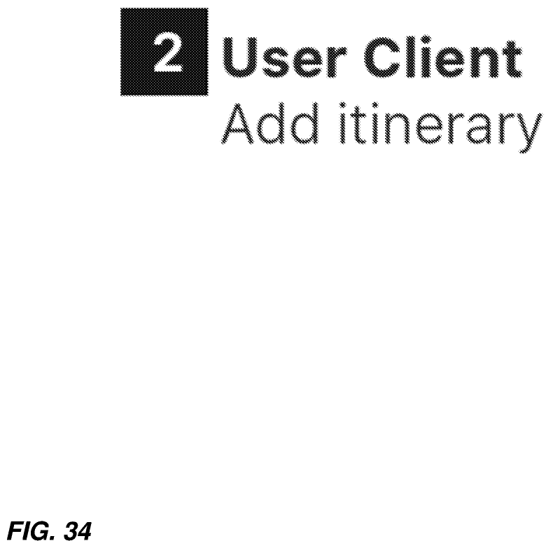

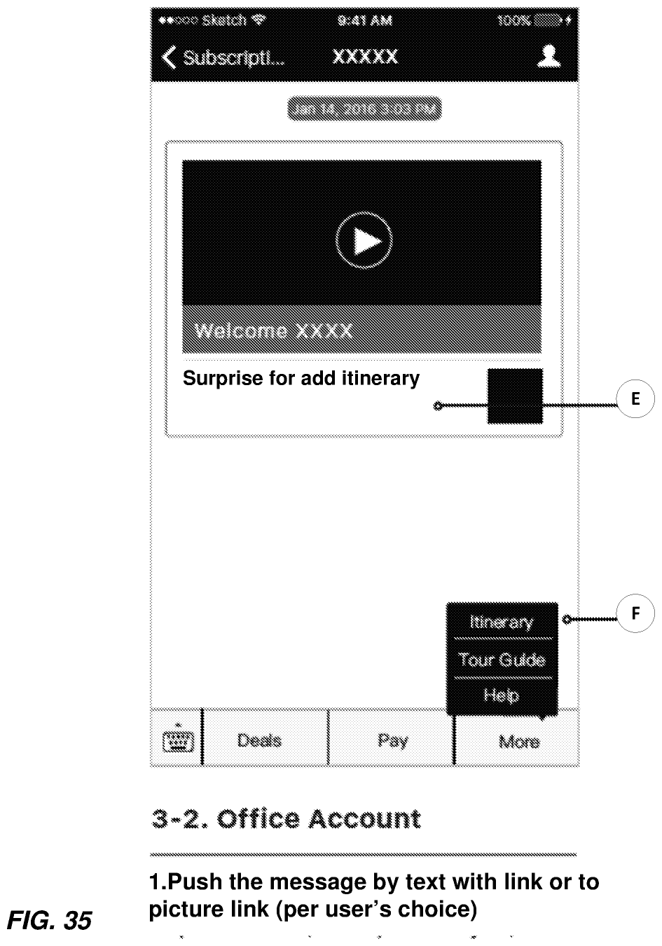

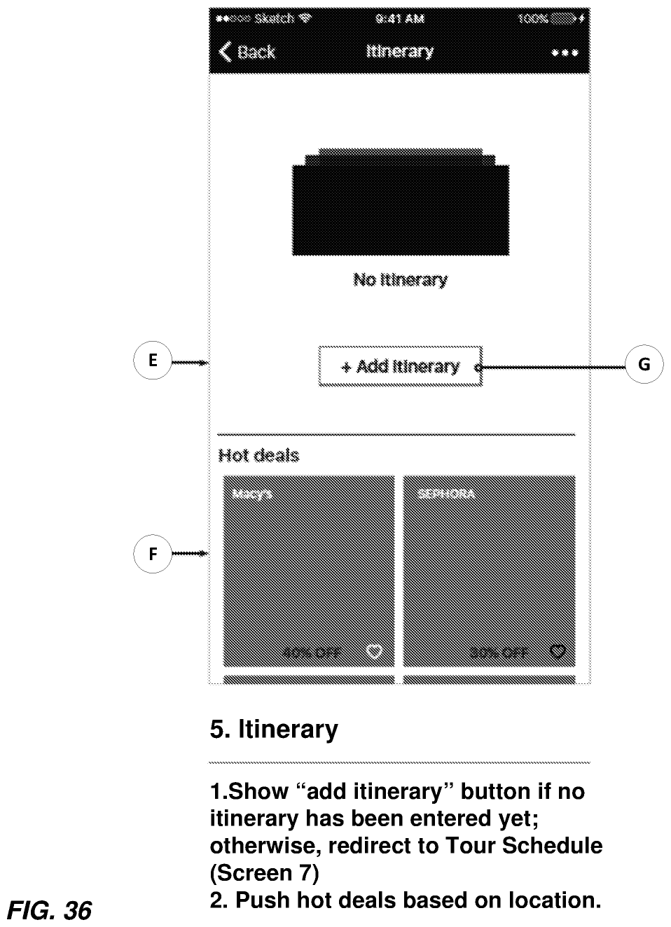

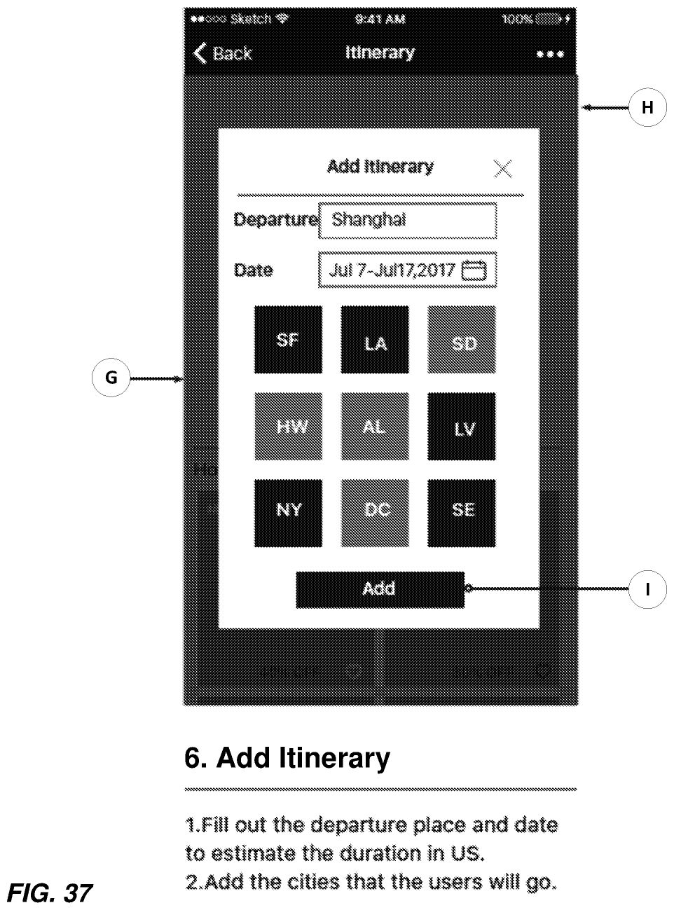

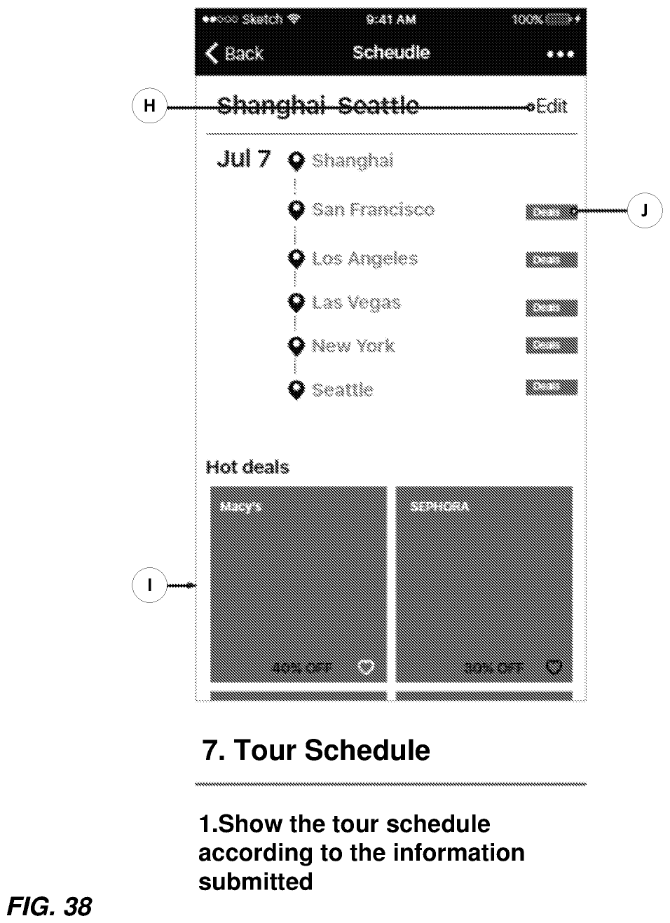

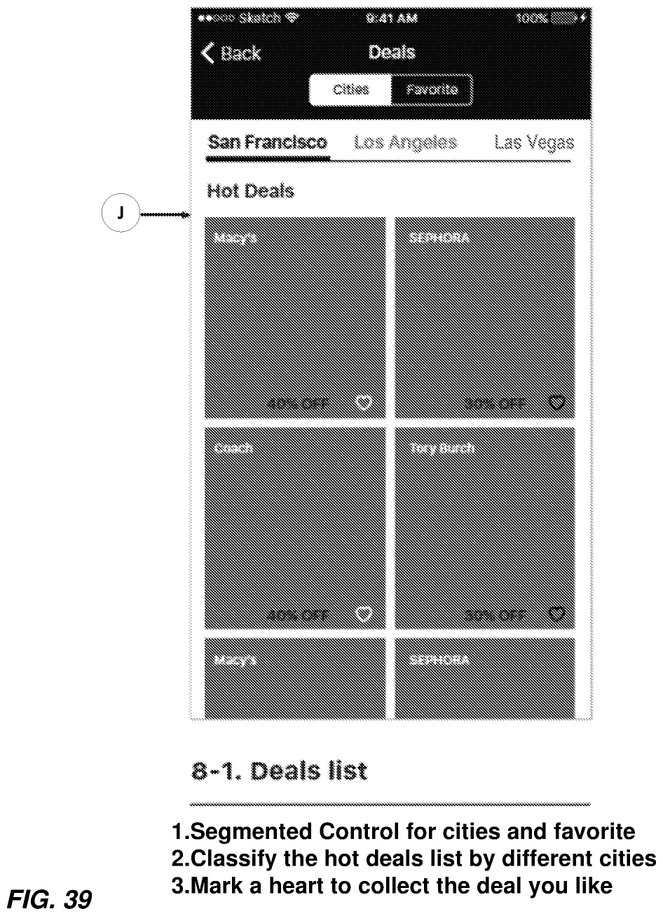

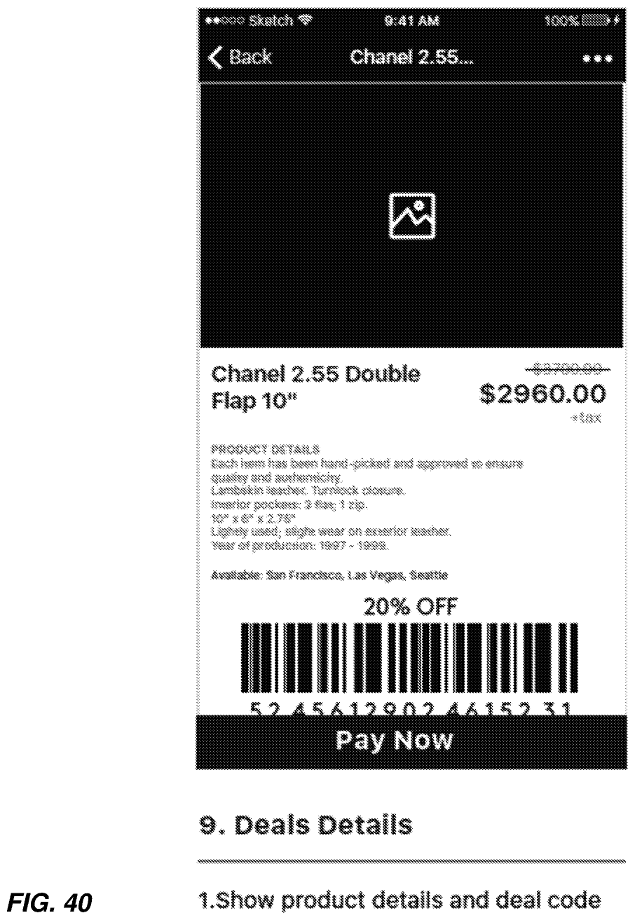

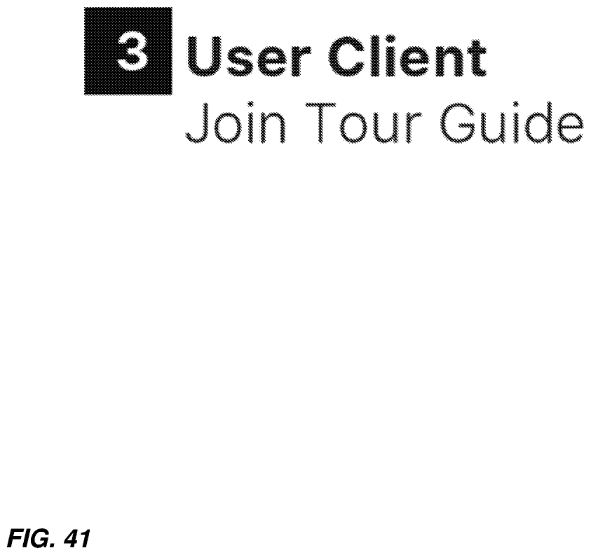

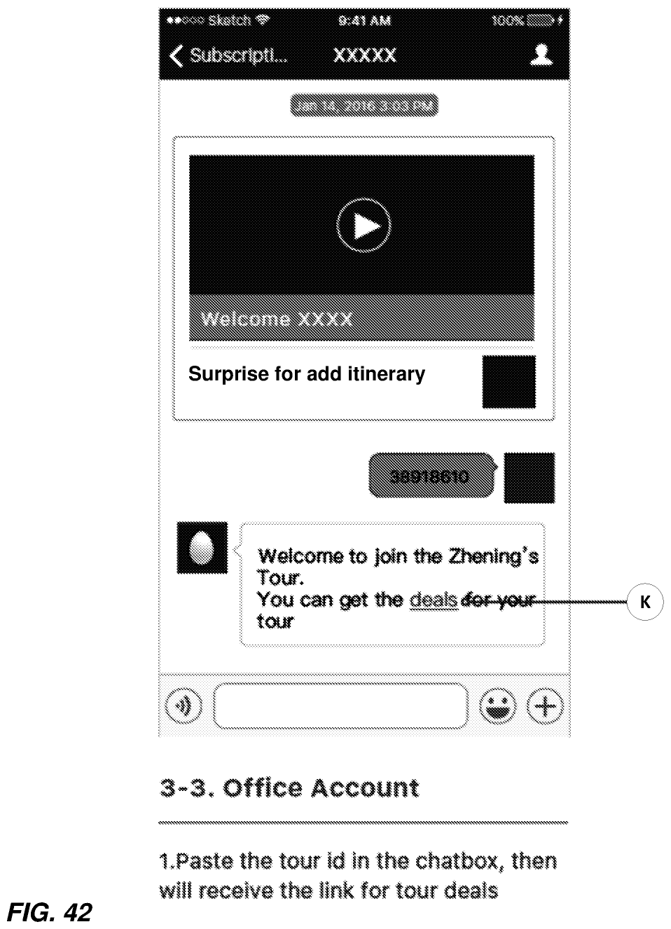

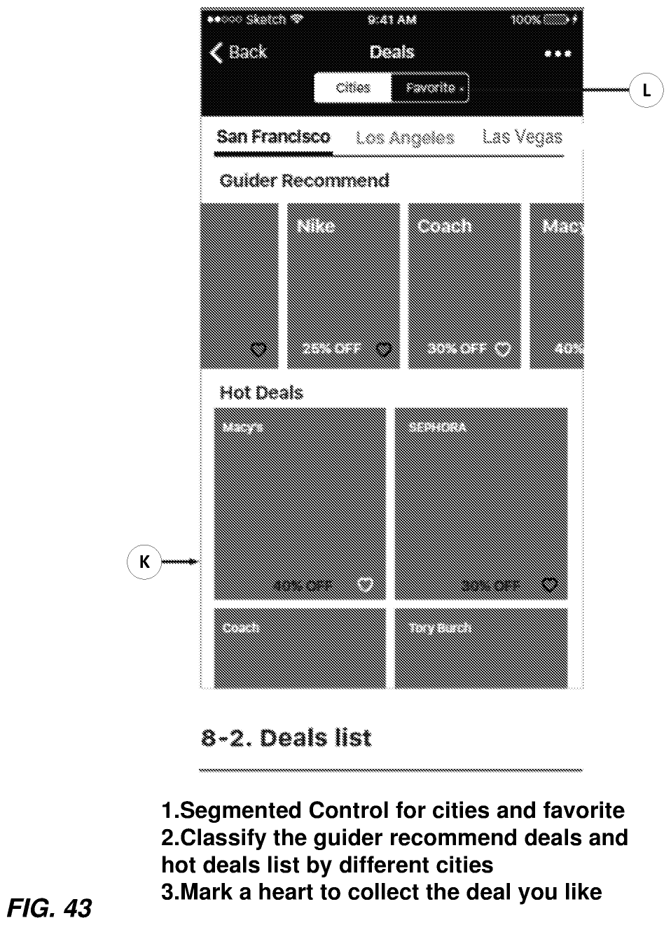

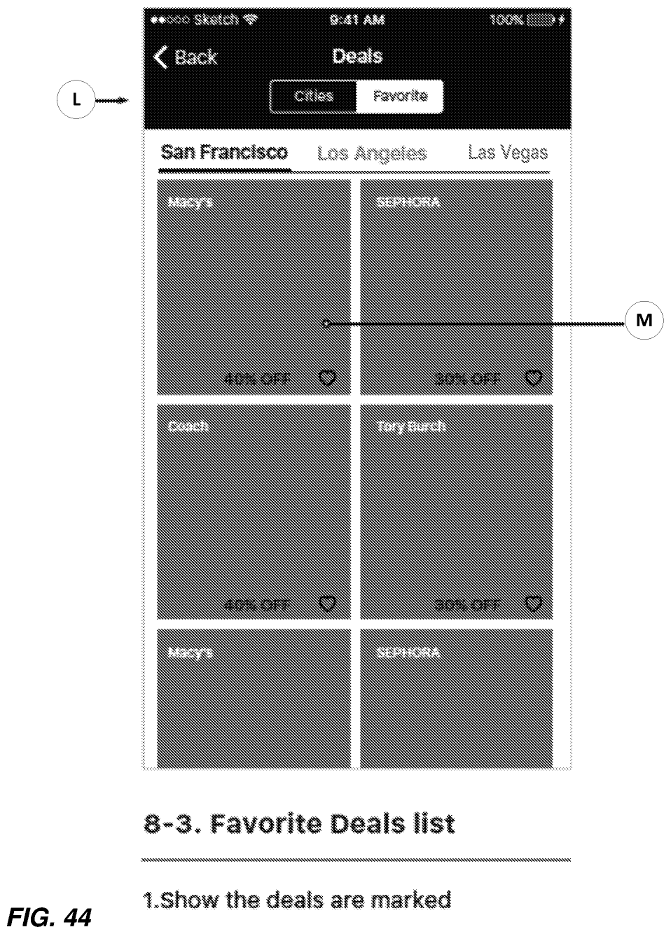

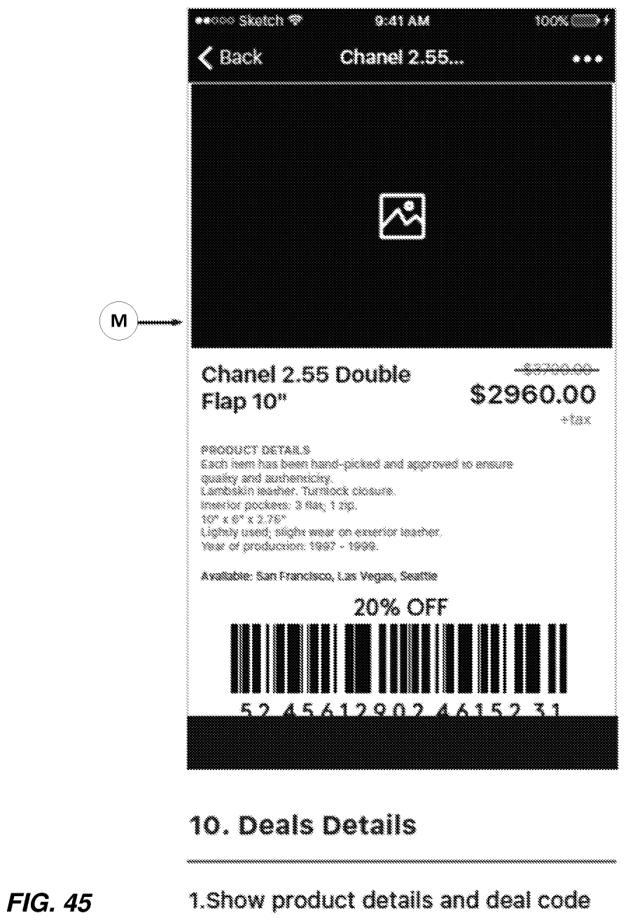

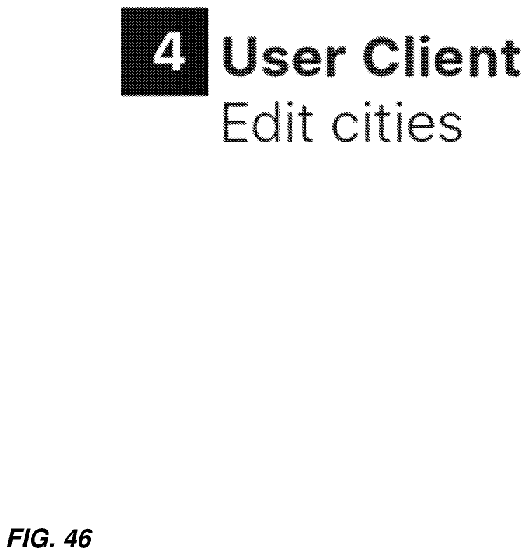

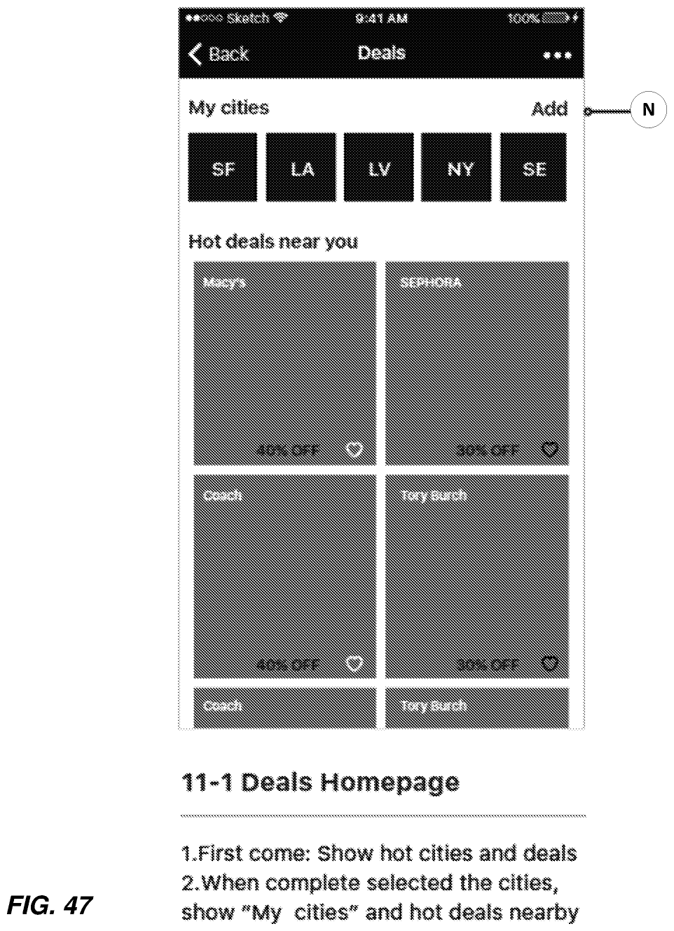

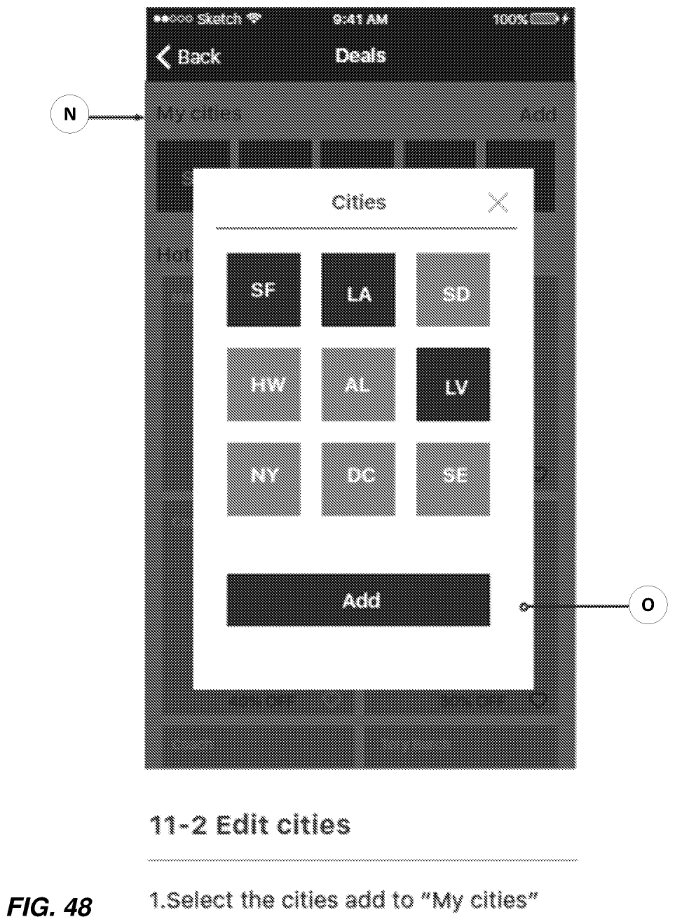

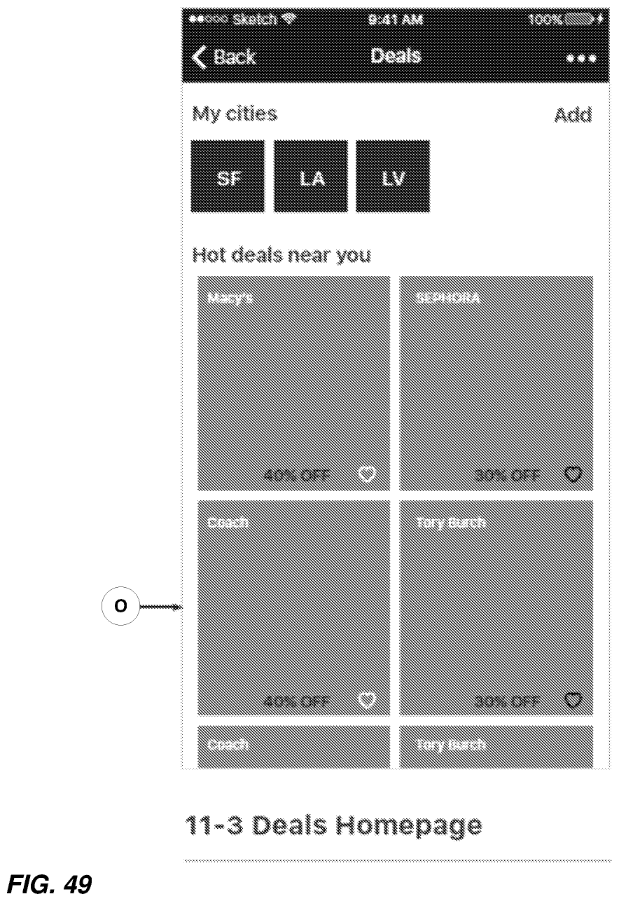

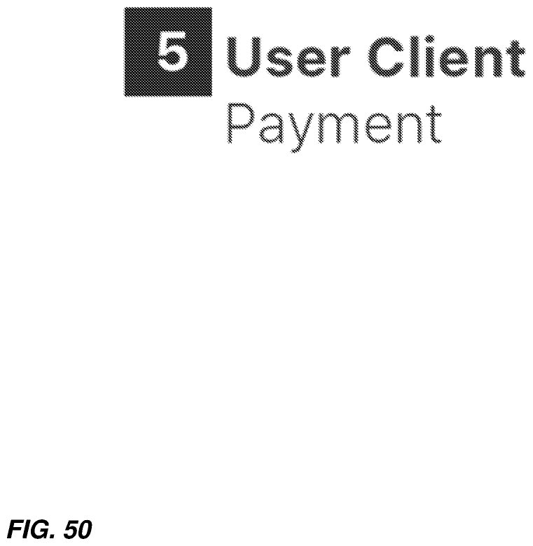

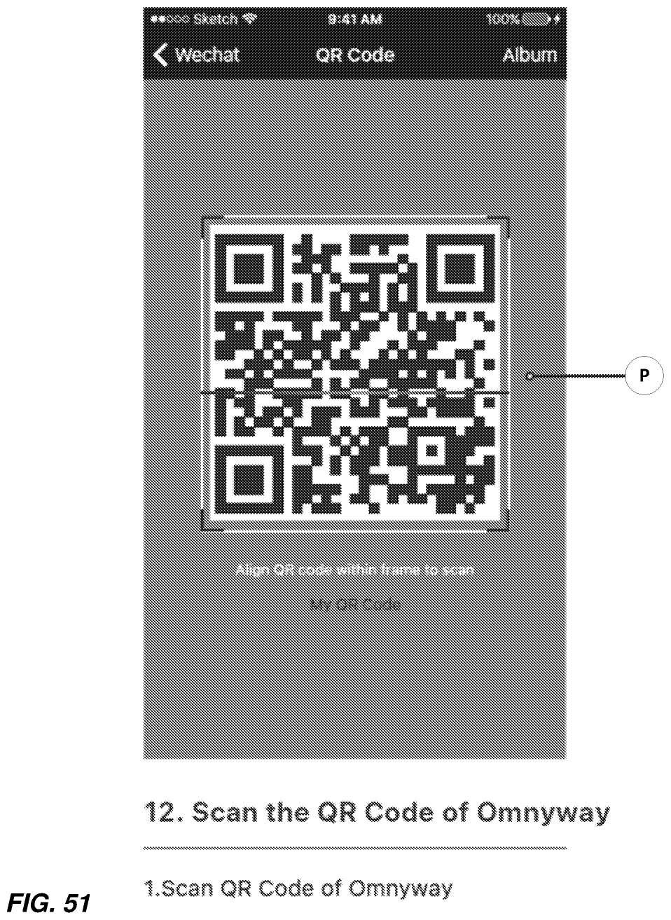

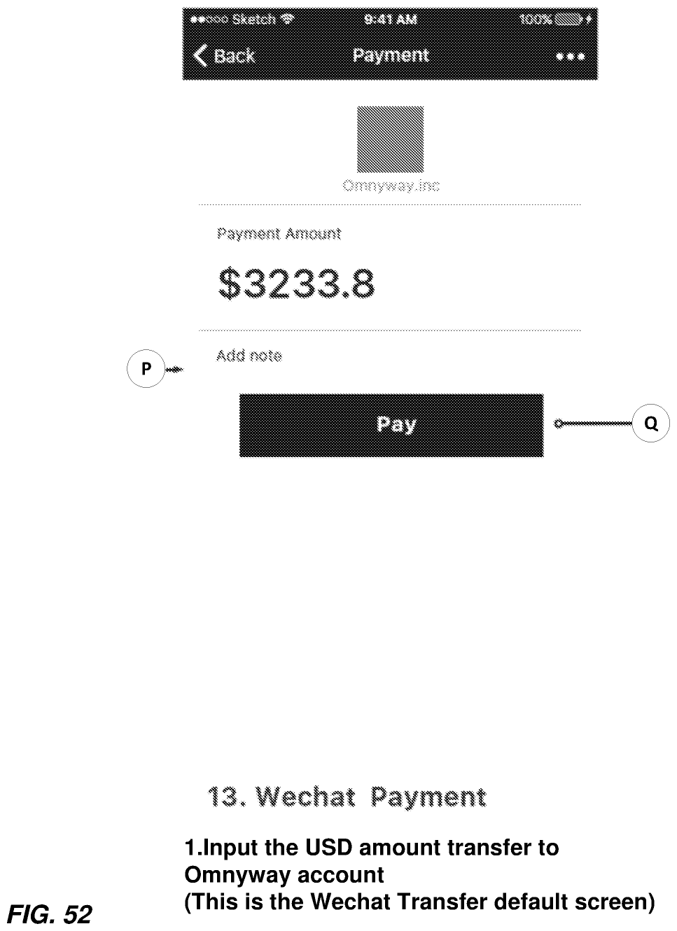

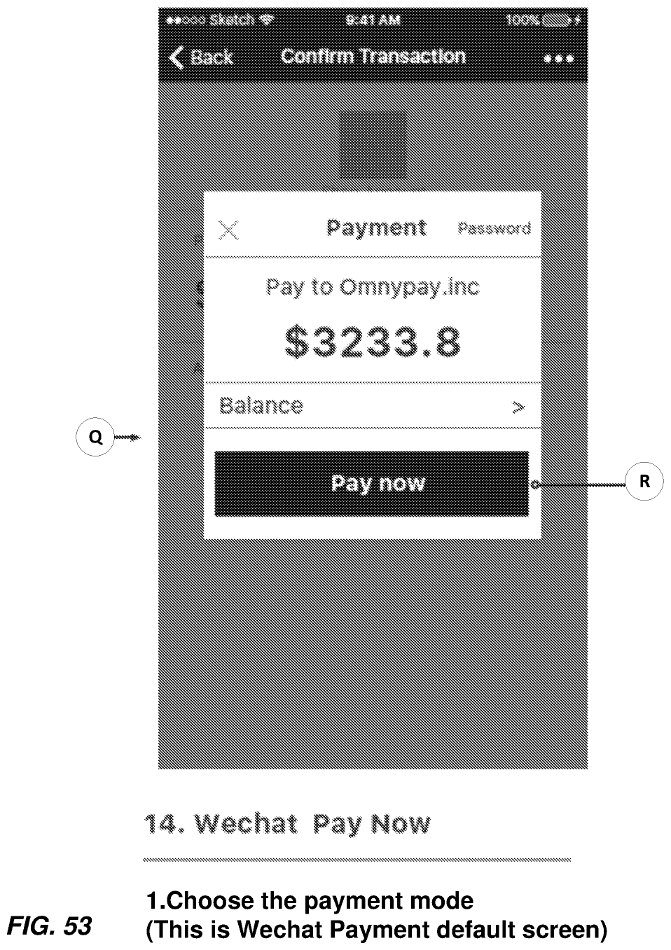

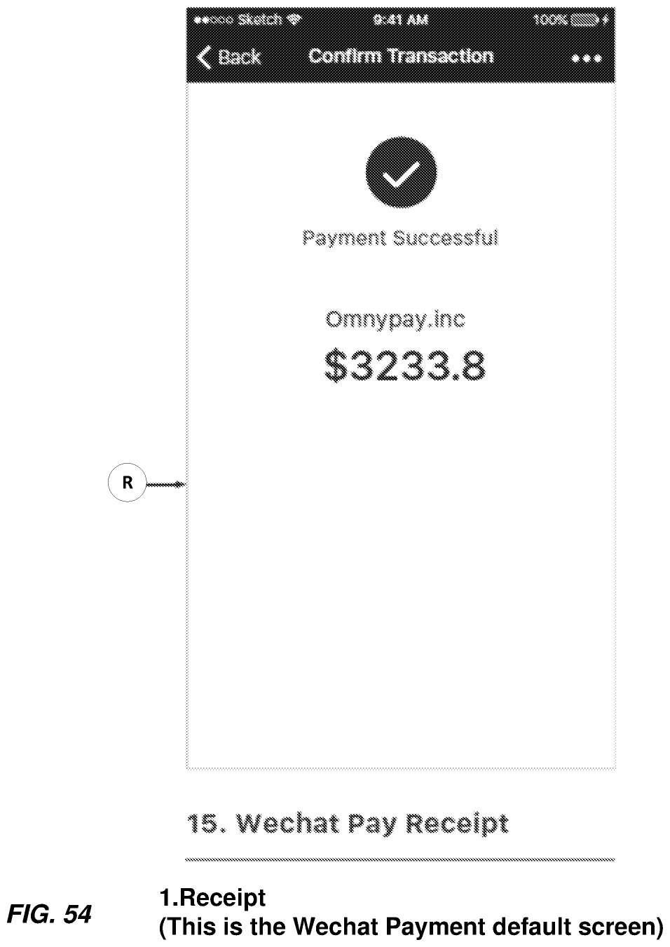

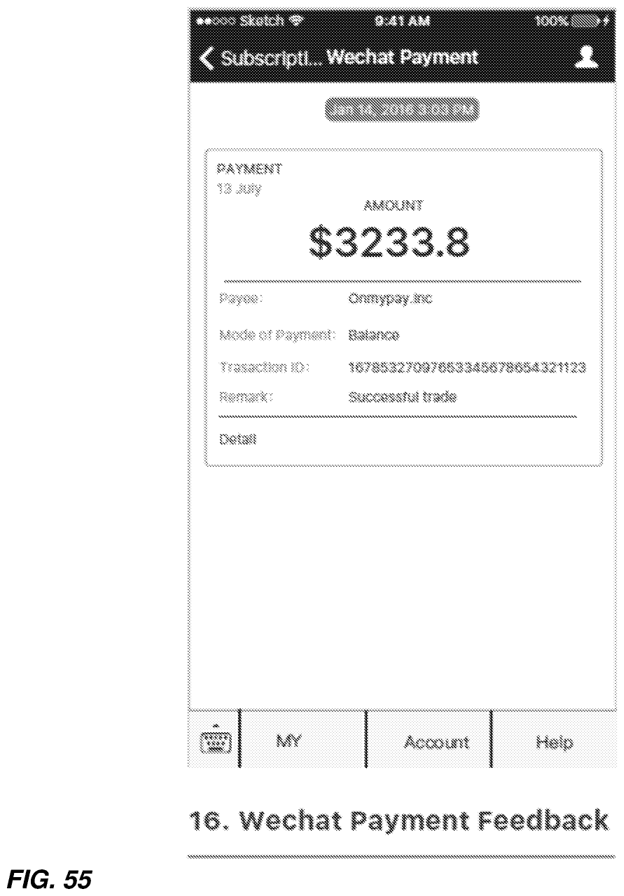

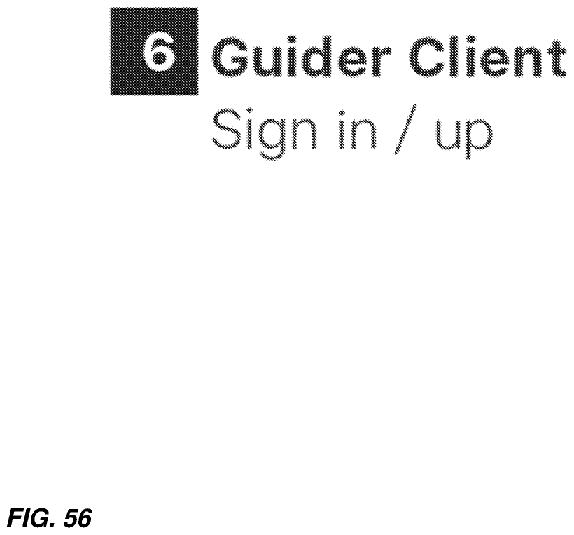

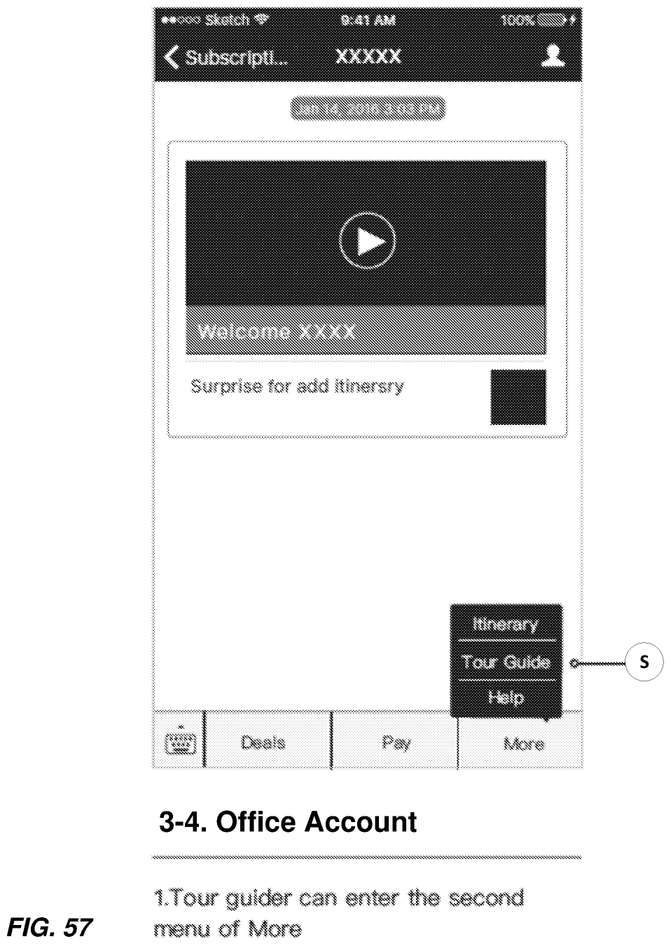

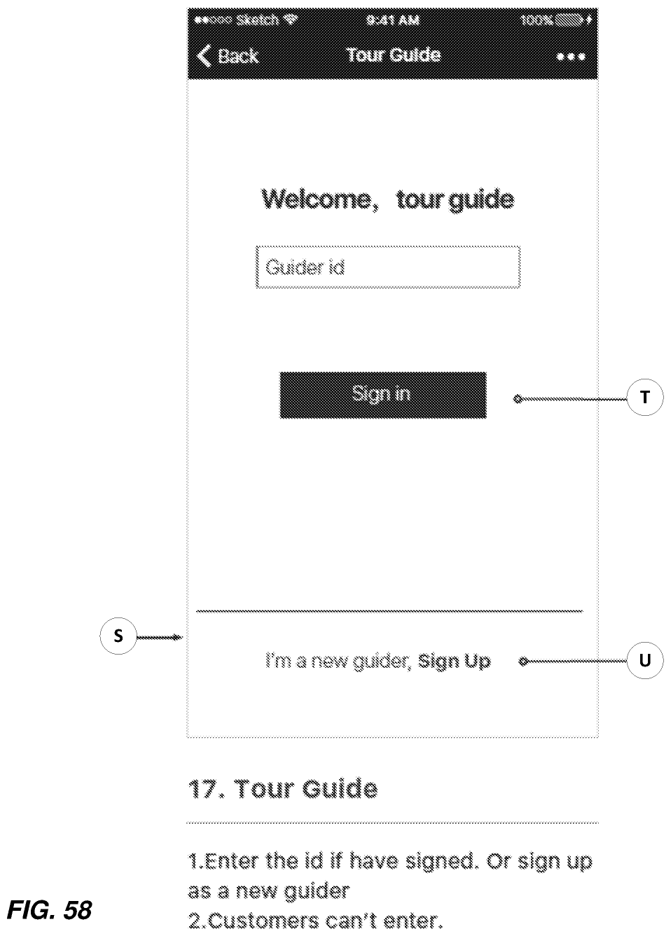

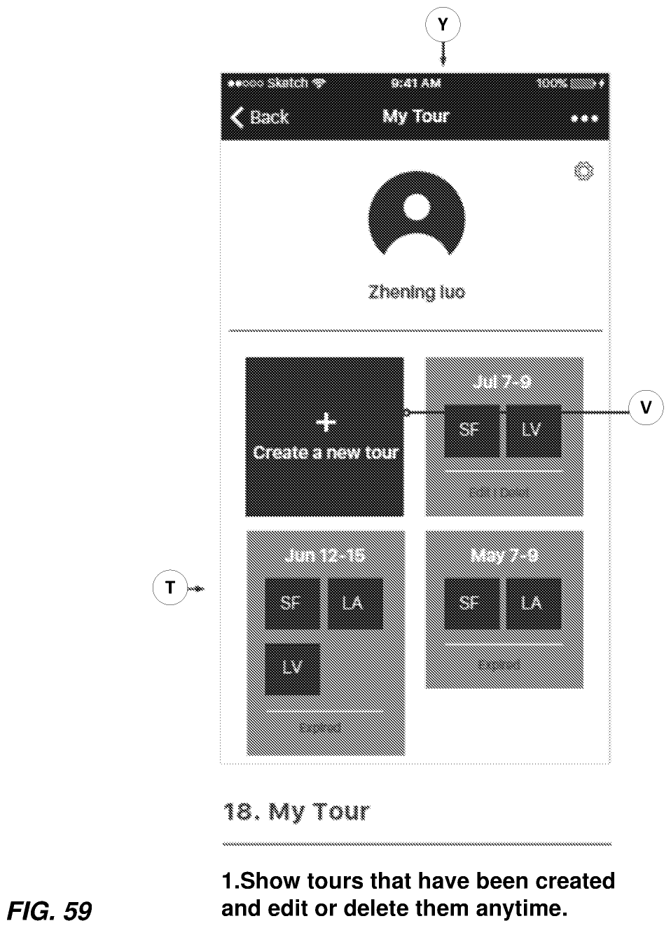

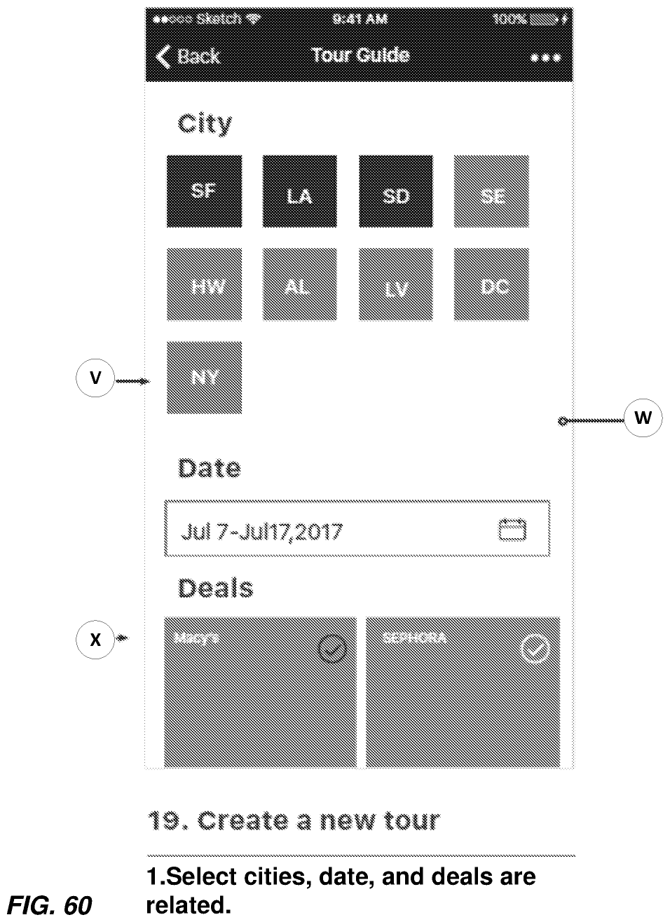

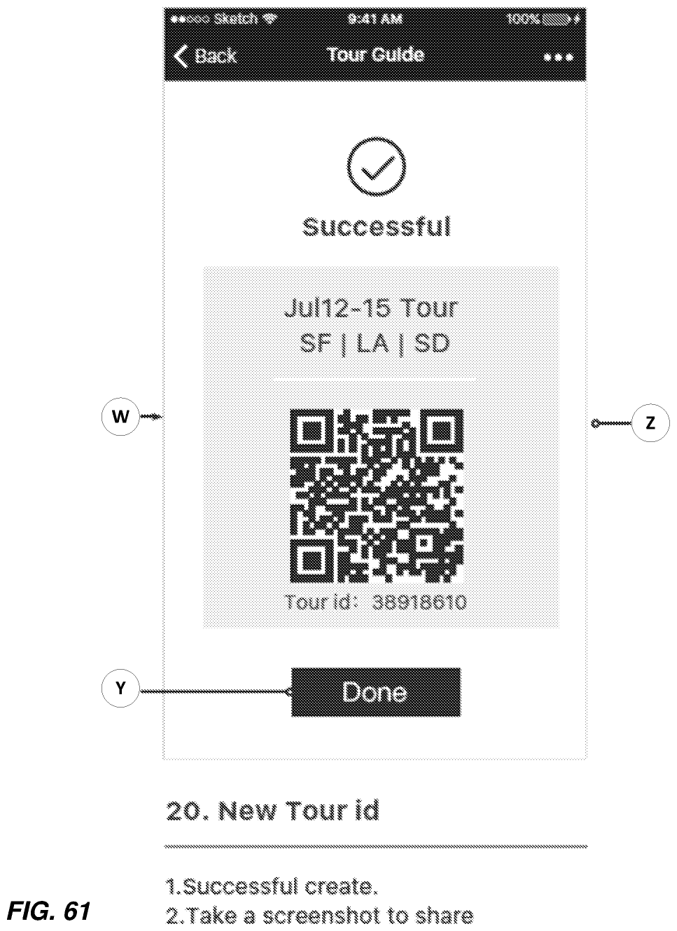

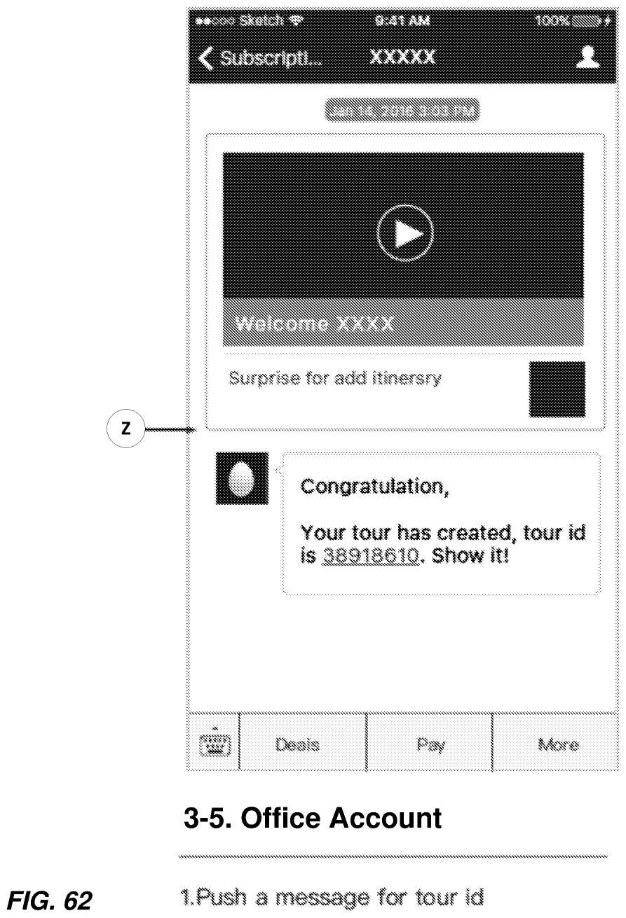

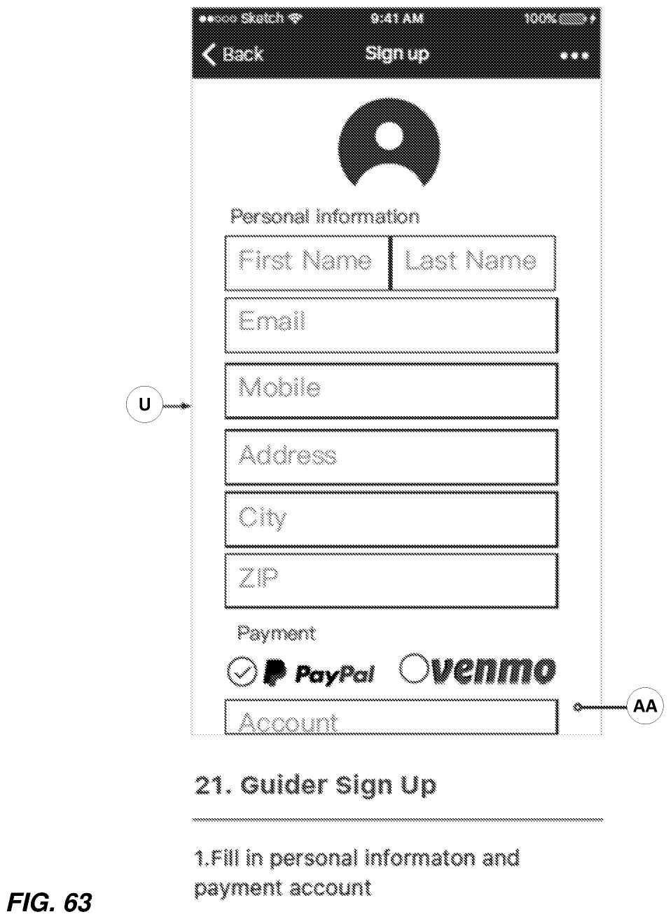

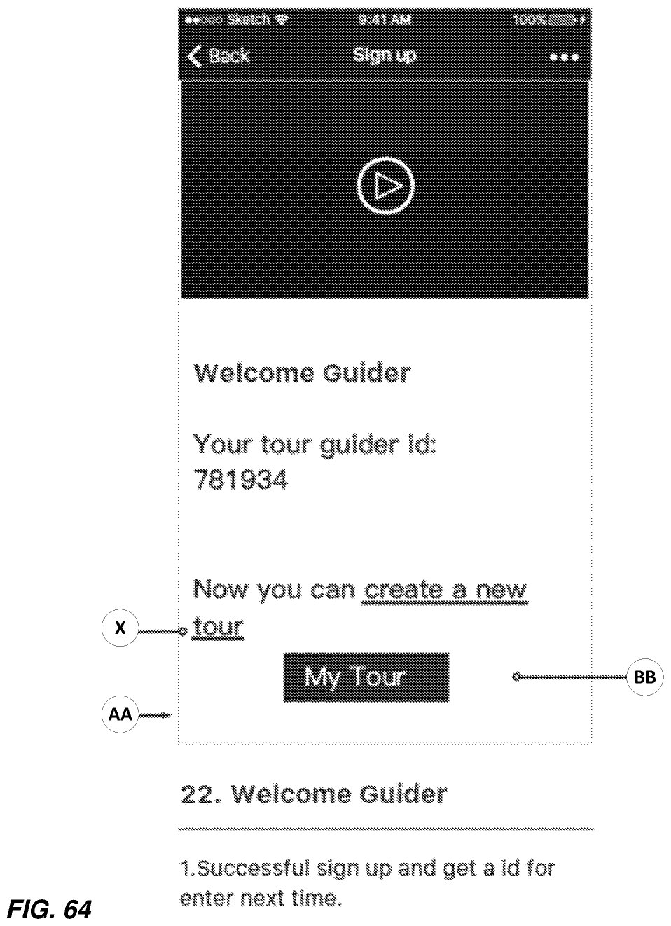

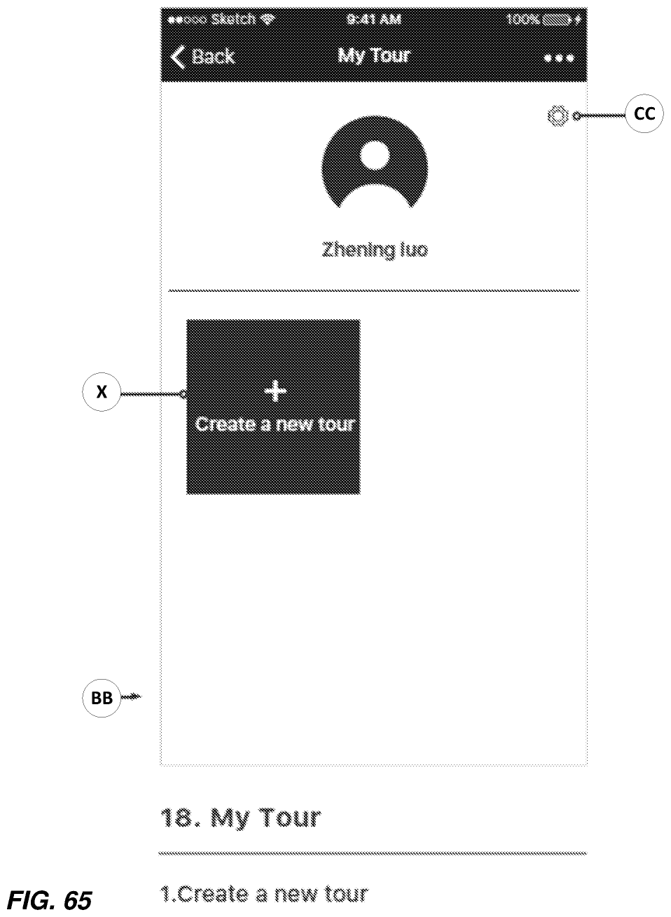

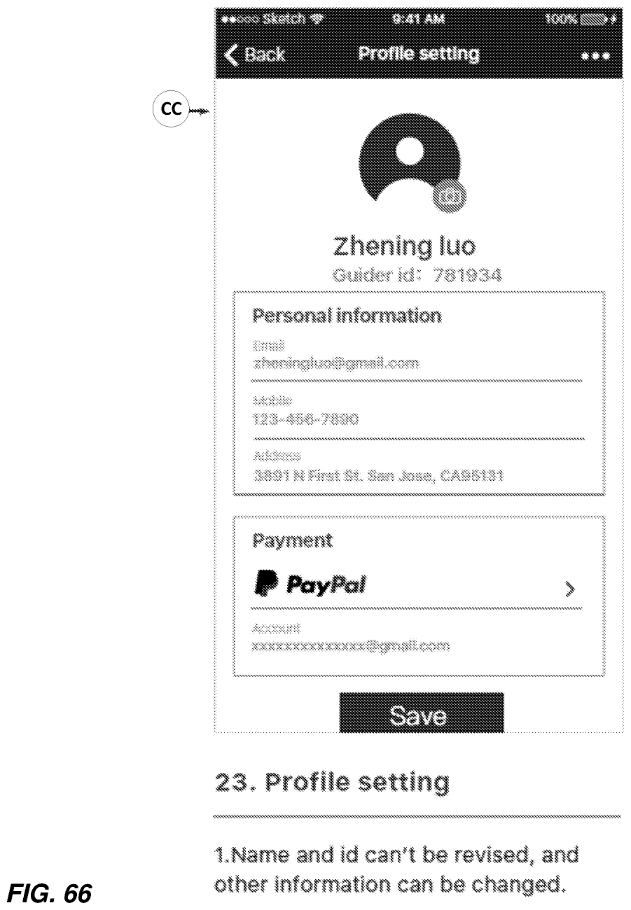

FIG. 29 through 66 are screen shots showing how such processes may appear to a user who is using a smart phone, tablet, or other graphic device to interact with a system for providing a universal, global, virtual-to-physical payment adapter according to another embodiment of the present disclosure. The examples shown in these Figures are intended to be illustrative and do not limit the scope of the present disclosure in any way.

### Other Aspects

Advantages of the systems and methods of the present disclosure include, but are not limited to: providing opportunities to bring foreign visitors to US businesses; providing opportunities to provide discounts and inducements to customers to come to particular merchants; providing a framework for shared fees, referral fees, affiliate fees, and the like.

In addition, the systems and methods of the present disclosure may be tuned to the customs, practices, and needs of particular countries. For example, in Germany, debit cards are used more frequently than credit cards; thus, in one embodiment, the “prepaid card” mechanism will not be used, in favor of another, equally valid mechanism. In another example, some countries only accept credit cards from a few, well-known providers, such as Visa™, Discover™ and MasterCard™; in these countries, the systems and methods of the present disclosure would coordinate with these providers instead of with WeChatPay™, for example. In yet another example, India has created a system called Aadhaar that links bank information to biometric information. Thus, in one embodiment, the OPS 12 may be configured to transmit, receive, and process biometric or other specialty information.

### Universal ID

In order to uniquely identify entities that participate in the OPS systems and methods of the present disclosure, in one embodiment the OPS 12 creates and maintains a universal identifier, or “universal ID”, for each individual. In one embodiment, an individual is a physical person. In one embodiment, a universal ID may be mapped to a combination of person +payment instrument. For example, a universal ID may be mapped to both one person with a Visa™ card and to another person with a MasterCard™ card.

In one embodiment, universal IDs may be logically grouped, e.g., as members of a business entity, as members of a family unit, or other logical groupings. In one embodiment, transactions are specific to a particular individual identified by a universal ID while discounts and promotions may be offered to individuals or to logical groups of individuals. In one embodiment, each logical group does not have its own universal ID, but in alternative embodiments, a logical group may have its own universal ID.

In one embodiment, the OPS 12 may include or communicate with a database for storing and maintaining universal ID information.

Those skilled in the art will recognize improvements and modifications to the preferred embodiments of the present invention. All such improvements and modifications are considered within the scope of the concepts disclosed herein and the claims that follow.

1. A method for providing a universal, global, virtual wallet to merchant payment system adapter, the method comprising:
at a networked application server:
receiving first information associated with a desired transaction, the information comprising information identifying a user, an amount, and a Point Of Sale (POS) terminal or other merchant payment system for performing the transaction;
using the information identifying the user to identify a mobile wallet application that allows transfer of funds from the user to another user but is inoperable with card payment acceptance systems, the mobile wallet application being associated with a first financial entity;
sending, to the first financial entity, a request to authorize the desired transaction, the request comprising information for identifying the user and the amount;
receiving, from the first financial entity, authorization of the desired transaction;
using the information identifying the POS terminal or other merchant payment system to identify the merchant;
determining a payment instrument associated with the merchant, the payment instrument to be involved in the transaction, the payment instrument issued by a second financial entity and operable with card payment acceptance systems;
sending, to the second financial entity, a request to prepare the payment instrument for the desired transaction;
receiving, from the second financial entity, an indication that the request was successful;
sending, to the identified user, an instruction to request the merchant to process the desired transaction using the payment instrument associated with the merchant at the POS terminal or other merchant payment system for performing the transaction; and
at the POS terminal or other merchant payment system:
processing the desired transaction using the payment instrument associated with the merchant at the POS terminal or other merchant payment system for performing the transaction, using a card payment acceptance system.

2. The method of claim 1 wherein the first financial entity and the second financial entity comprise domestic banks.

3. The method of claim 1 wherein:
the first financial entity comprises a foreign bank and wherein the second financial entity comprises a domestic bank; or
the first financial entity comprises a domestic bank and wherein the second financial entity comprises a foreign bank and wherein receiving the first information comprises receiving the first information from a mobile application or personal computer of the user.

4. The method of claim 3 wherein receiving the information identifying an amount comprises receiving information identifying an amount in a first currency and wherein the method further comprises, prior to sending the request to authorize the desired transaction:
converting the amount in the first currency to an amount in a second currency;
sending the amount in the second currency to the user for approval; and
receiving from the user approval to send the request to authorize the desired transaction.

5. The method of claim 1 wherein:
sending the request to prepare the payment instrument or financial account for the desired transaction comprises sending a request that funds be added to the payment instrument and/or that a credit limit of the payment instrument be changed.

6. The method of claim 1 wherein
the first information associated with a desired transaction is received from a mobile device of the user.

7. The method of claim 1 further comprising:
receiving an indication of the result of the processed transaction; and
notifying the user of the result of the processed transaction.

8. A payment server for providing a universal, global, virtual wallet to merchant payment system adapter, the payment server comprising:
at least one processor; and
memory comprising instructions executable by the at least one processor whereby the payment server is configured to:
receive first information associated with a desired transaction, the information comprising information identifying a user, an amount, and a Point Of Sale (POS) terminal or other merchant payment system for performing the transaction;
use the information identifying the user to identify a mobile wallet application that allows transfer of funds from the user to another user but is inoperable with card payment acceptance systems, the mobile wallet application being associated with a first financial entity;
send, to the first financial entity, a request to authorize the desired transaction, the request comprising information for identifying the user and the amount;
receive, from the first financial entity, authorization of the desired transaction;
use the information identifying the POS terminal or other merchant payment system to identify the merchant;
determine a payment instrument associated with the merchant, the payment instrument to be involved in the transaction, the payment instrument issued by a second financial entity and operable with card payment acceptance systems;
send, to the second financial entity, a request to prepare the payment instrument for the desired transaction;
receive, from the second financial entity, an indication that the request was successful; and
send, to the identified user, an instruction to request the merchant to process the desired transaction using the payment instrument of the merchant at the POS terminal or other merchant payment system for performing the transaction.

9. The payment server of claim 8 wherein the first financial entity and the second financial entity comprise domestic banks.

10. The payment server of claim 8 wherein the first financial entity comprises a foreign bank and wherein the second financial entity comprises a domestic bank.

11. The payment server of claim 10 wherein receiving the information identifying an amount comprises receiving information identifying an amount in a first currency and wherein the payment server is further configured to, prior to sending the request to authorize the desired transaction:
convert the amount in the first currency to an amount in a second currency;
send the amount in the second currency to the user for approval; and
receive from the user approval to send the request to authorize the desired transaction.

12. The payment server of claim 9 wherein:
sending the request to prepare the payment instrument for the desired transaction comprises sending a request that funds be added to the payment instrument and/or that a credit limit of the payment instrument be changed.

13. The payment server of claim 8 wherein
the first information associated with a desired transaction is received from a mobile device of the user.

14. The payment server of claim 8 wherein the payment server is further configured to:
receive an indication of the result of the processed transaction; and
notify the user of the result of the processed transaction.

15. The payment server of claim 8 wherein the payment server is further configured to:
present participating local merchants' offers and/or product information graphically, in text, or in voice to users;
identify merchants that support the services provided by the payment server; and/or
incite users through discounts or offers to visit and make purchases at participating local merchants.

16. The payment server of claim 15 wherein the payment server provides notifications to the user via a social media app, a mobile app, or a personal computer.

17-20. (canceled)

21. A non-transitory computer readable medium storing software instructions that, when executed on at least one processor, cause the at least one processor to:
receive first information associated with a desired transaction, the information comprising information identifying a user, an amount, and a Point Of Sale (POS) terminal or other merchant payment system for performing the transaction;
use the information identifying the user to identify a mobile wallet application that allows transfer of funds from person to person but is inoperable with card payment acceptance systems, the mobile wallet application being associated with a first financial entity;
send, to the first financial entity, a request to authorize the desired transaction, the request comprising information for identifying the user and the amount;
receive, from the first financial entity, authorization of the desired transaction;
use the information identifying the POS terminal or other merchant payment system to identify the merchant;
determine a payment instrument associated with the merchant, the payment instrument to be involved in the transaction, the payment instrument being associated with a second financial entity and operable with card payment acceptance systems;
send, to the second financial entity, a request to prepare the payment instrument for the desired transaction;
receive, from the second financial entity, an indication that the request was successful; and
send, to the identified user, an instruction to request the merchant to process the desired transaction using the payment instrument of the merchant at the POS terminal or other merchant payment system for performing the transaction.

22. (canceled)
